(19) United States
(12) Patent Application Publication
(10) Pub. No.: US 2026/0368631 A1
(43) Pub. Date: Nov. 19, 2026

(54) ACCELERATING MACHINE LEARNING PIPELINES ON DISTRIBUTED SYSTEMS WITH MEDIATION-BASED DATA PLACEMENT AND STORAGE LOCAL COMPUTE

(71) Applicant: HEWLETT PACKARD ENTERPRISE DEVELOPMENT LP, Spring, TX (US)

(72) Inventors: Sridhar Balachandriah, Bangalore (IN); Porno Shome, Bengaluru (IN); Shreyas Vinayaka Basri K S, Bangalore (IN); Hemant Jain, Bangalore (IN); Sherin Thyil George, Bangalore (IN); Lance MacKimmie Evans, Fort Collins, CO (US); Chinmay Ghosh, Bangalore (IN)

(21) Appl. No.: 19/284,506

(22) Filed: Jul. 29, 2025

(30) Foreign Application Priority Data
May 14, 2025 (IN) 202541046570

(51) Int. Cl. G06N 20/00

(52) U.S. Cl. CPC G06N 20/00

(57) ABSTRACT

Systems and methods are provided for accelerating execution of machine learning (ML) pipelines on distributed systems by mediating contentions that may occur while executing workloads and reconfiguring the distributed system for subsequent workloads. Examples obtain performance metrics from a distributed object storage related to an execution of a first workload of an ML pipeline and identify first contention candidates based on detecting performance drops in the performance metrics. Examples detect contentions from the first contention candidates based on correlations with second contention candidates obtained from a second workload, determine a configuration of the distributed system based on the detected contentions, and deploy the determined configuration on the distributed system.

### BACKGROUND

The use of Artificial Intelligence (AI) and Machine Learning (ML) has spread through many industries such as healthcare, manufacturing, finance, and life science, and deep learning with large datasets and is now used for solving real-world problems in such industries. AI and ML architectures are evolving at a rapid pace with advancements in software and hardware, offering performance benefits in AI/ML workloads.

An ML workflow defines phases implemented during an ML project, which consists of ML pipelines that orchestrate the flow of data into, and output from, the ML workflow. Each ML pipeline can include the phases with workloads, such as, but not limited to, data ingestion, pre-processing, feature engineering, model training, model evaluation, and inference. The ML pipelines aim to streamline the ML workflow by automating the phases of each ML pipeline. A single ML project may consist of multiple ML pipelines that can be executed separately, as well as in parallel. Example ML pipelines include, but are not limited to, a feature engineering pipeline that focuses on data pre-processing and feature engineering, a training pipeline that focuses on model training and evaluation, and an inference pipeline that focuses on deploying the trained model.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 depicts a schematic block diagram of a distributed environment including a contention mediation system, in accordance with implementations of the disclosure.

FIG. 2. Illustrates an example contention mediation system, in accordance with examples of the present disclosure.

FIG. 3 is a flow chart of an example optimized storage local compute flow, in accordance with an example of the present disclosure.

FIG. 4 is a flow chart of an example optimized data placement flow, in accordance with an example of the present disclosure.

FIG. 5 is a flow chart of an example contention identification flow, in accordance with an example of the present disclosure.

FIG. 6 illustrates a graphical representation of a performance metric related to an execution of a workload.

FIG. 7 illustrates a smoothened graphical representation of the performance metric illustrated in FIG. 6.

FIGS. 8A and 8B depict a flow chart of an example rhythm detection flow, in accordance with an example of the present disclosure.

FIG. 9 illustrates a process flow 900 for contention mediation in accordance with an example implementation.

FIG. 10 illustrates a computing component that may be used to implement contention mediation in accordance with various examples of the disclosed technology.

FIG. 11 illustrates a computing component that may be used to implement I/O contention mediation in accordance with various examples of the disclosed technology.

FIG. 12 depicts a block diagram of an example computer system in which various examples of the disclosed technology described herein may be implemented.

The figures are not exhaustive and do not limit the present disclosure to the precise form disclosed.

### DETAILED DESCRIPTION

Examples of the technology disclosed herein provide systems and methods for mediating contentions that may occur while executing an ML pipeline workload and reconfiguring the distributed storage for subsequent workloads. A workload, as used herein, may refer to an instance of executing an ML pipeline or an instance of executing one or more phases of the ML pipeline. An ML pipeline can be executed by a distributed system (e.g., distributed compute infrastructure and/or distributed storage), with a distributed application executing workloads. Examples herein obtain performance metrics from the distributed system related to an execution of a workload and identify contention candidates based on performance degradations (also referred to herein as performance drops) within the performance metrics. Contentions can be detected by correlating contention candidates across multiple workload executions. A configuration of the distributed storage can be determined that mitigates the detected contentions. The configuration can be deployed on the distributed storage to reconfigure the distributed storage so to mitigate contentions during a subsequent execution of the workload, thereby improving executions of the ML pipeline.

AI and ML environments are constantly evolving with software and hardware to gain performance benefits and deliver faster, more consistent, and increasingly accurate outcomes. ML pipeline workloads can rely on distributed execution environments comprising of numerous compute nodes providing computation power, consuming varying amounts of network bandwidth, vast memory capacity, and a multitude of storage input/output (I/O) operations (collectively referred to as computation resources) working cohesively to deliver predictable outcomes for the trained objective. The evolution of the ML pipelines may be inexorable and can impose multifarious data access requirements on storage platforms. Non-optimized performance amongst the computation resources may be a result of hardware and software failures, interoperable issues, and hardware customized for particular software requirements. Data storage may need to evolve dynamically and with great promptitude to address the performance advancement of AI and ML environments.

Distributed ML pipelines running on non-optimized and improper utilization of computation resources can contribute to a reduction in overall efficiency of the execution environment. Distributed ML pipeline is a technique in which workloads of an ML pipeline, as well as applications executing the workloads, can be distributed across multiple systems networked together (sometimes referred to herein as a cluster) so to consolidate the execution. Performance of distributed ML pipelines can be affected by computation constraints at various portions of execution. If distributed workloads are compute intensive with relatively longer times to solution, subsequent tasks may be queued and starved for compute time due to lack of available compute nodes (e.g., CPU cores and the like). Scalability within a distributed cluster can also be another issue, with minimal or no room to add on-demand compute nodes to serve ML pipeline requirements. Furthermore, storage platforms may be over-provisioned, which inhibits possible expansion at a later point in time, resulting in unused computation resources becoming inaccessible to the workloads.

ML pipelines operating concurrently in a distributed environment may face challenges in computation resource depletion due to the swiftly evolving AI landscape. Computation resource depletion refers to the exhaustion of computation resources due to excessive demand on the resources or inefficient utilization. Such depletion may arise from non-isolation of storage workloads (e.g., I/O operations into and out of a storage platform) from compute workloads (e.g., processing executions performed by a compute nodes) within an ML pipeline. Another source of the depletion may be non-optimized data placement choices on distributed storage platforms for dynamic multifarious workload. Furthermore, non-utilization of overprovisioned compute nodes in distributed storage platforms and a lack of intelligent reconciliation mechanism within the distribute storage platform and computation systems that can yield consistent outcomes may increase depletion challenges.

Against this backdrop, examples disclosed herein provide for systems and methods that can mitigate computation resource depletion by detecting contentious portions of an ML pipeline and recommend configurations of a distributed storage that can optimize an execution environment in which an ML pipeline is executed. Examples herein can analyze the compute and storage requirements of an ML pipeline, assess the capabilities of the underlying storage platform, and provide recommendations for improved and optimized outcomes. The examples herein may also reconcile the recommendations into actions, for example, by mapping workload requirements to storage capabilities, which may provide increases in model training performance with reduced cost. In some examples, the recommendations may be provided to an administrator for approval prior to execution. In another example, the actions may be automated without administrator input.

As alluded to above, examples disclosed herein provide systems and methods for mediating contentions that may occur while executing an ML pipeline workload on a distributed application in a distributed environment (also referred to herein distributed system) and reconfiguring a distributed object storage for executing subsequent workloads. For example, data access contentions (e.g., contentions in I/O operations on a storage platform) can be mediated and the execution environment optimized to mitigate such contentions. In examples, performance metrics can be obtained from a distributed environment related to an execution of a first workload of an ML pipeline. For example, performance metrics can be obtained from one or more of a distributed object storage compute infrastructure, and network infrastructure. First contention candidates may be identified based on detecting performance drops in the performance metrics. Contentions can be detected from the first contention candidates by correlating the first content candidates with second contention candidates obtained from an execution of a second workload. A configuration for the distributed object store can be determined based on the detected contentions, which can be deployed on the distributed object store for use in executing a subsequent workload of the ML pipeline.

In some examples, the performance metrics may include characterizations of I/O operations on the distributed object storage. In this case, the correlations of the first content candidates with second contention candidates may be indicative of a repeated pattern of contentions between I/O operations related to the execution of the ML pipeline. Information of the execution environment in which the first and second workloads are executed can be associated with the correlated contention candidates and used to identify similarities in the configurations of the execution environment. The similarities can be leveraged to identify a root cause of the contentions.

Characterizations of I/O operations may include, but are not limited to, a number of compute processing units (e.g., number of CPUs, number of GPU, and the like) utilized for each workload (or each task of a workload), a kind of I/O generated at the distributed object storage (e.g., a data block size, such as 4 KB, 8 KB, 16 KB, 4 MB, and so on), a total number of processors utilized for the I/O operations.

In some examples, the performance metrics may comprise a set of performance data points. The performance data points may be provided as time-series data comprising performance metric data (e.g., normalized valuations of performance) and times (e.g., timestamps) at which the performance metric was measured. In examples, the first contention candidates can be identified based on detecting performance drops in the performance metric by identifying one or more subsets of the performance data points that satisfy performance deviation criteria. The one or more subsets of the performance data points may be stored as the contention candidates. In examples, detecting contentions from the first contention candidates can include retrieving the second contention candidates and iteratively computing, using a rhythm detection algorithm (RDA), correlation values between the first contention candidates and the second contention candidates. Responsive to a current correlation value being less than a preceding correlation value, examples herein may construct a set of correlated entries that are indicative of contentions. The set of correlated entries may include subsets of the first contention candidates and second contention candidates corresponding to the preceding correlation value.

In an illustrative example, the presently disclosed technology provides a Progressive Optimized Mediation Engine (POME) configured to mediate and reconfigure a distributed object storage for performing workloads of an ML pipeline. Examples of a distributed object storage may include, but are not limited to, a Distributed Asynchronous Object Store (DAOS). The POME may include a mediation module configured to gather information between compute and storage infrastructures of the distributed object store, detect contentious points of the ML pipeline performance, and provide solutions to mitigate the detected contentions by reconfiguring the distributed object store. In examples, the mediation module may include a Contention Identification Algorithm (CIA) that can be executed to isolate portions (e.g., operations) of a workload as contention candidates, which may be candidates for refactoring and executing on storage nodes. The mediation module may also include an RDA that can be executed to detect contentious rhythms by comparing contention candidates across successive executions of the ML pipeline. In some examples, the POME may also include a reconciliatory engine configured to interface with users for assent and deployment of recommendations into the execution environment.

A discovery engine can also be included that obtains telemetry data from the distributed object store environment, such as performance metrics (such as, for example, network bandwidth in terms of gigabits per second (GBps) or I/Os per second (IOPS), latency mapped to workloads, and the like) and execution environment information. The execution environment information may include, but is not limited to, workload states, events and pipeline execution dependencies (e.g., software and library dependencies), and configuration information. The configuration information may include information descriptive of computation resources utilized to execute workloads, such as compute nodes providing compute power, utilized network bandwidth, memory capacity (e.g., number of storage nodes, including available storage capacity), storage I/O threads. The telemetry data may be provided as time-series data, for example, by associating information with times at which the information occurred.

In operation, a user can initiate an ML pipeline run of a first workload (e.g., trigger execution of the tasks of the first workload) using a first configuration of the distributed object store. The discovery engine can capture information about the execution environment, including workload states, current execution environment information, performance metrics, and other telemetry data. The performance metrics can be processed by the mediation module using the CIA and the rhythm detection algorithm to detect contentions in the executing environment. For example, the CIA may apply performance deviation criteria to detect drops in performance followed by periods of steady performance that exceed a threshold period of time (referred to herein as performance landings or landings). Performance metrics satisfying one or both criterion (e.g., both a drop in performance and a landing exceeding the threshold period of time) represent performance drops during the execution of the first workload that can be considered contention candidates. The resources and events related to the contention candidates (e.g., execution environment information) can be retained for subsequent analysis. The CIA may output the performance data points corresponding to the performance drop as a set of contention candidates. The contention candidates may be associated to related execution environment information.

The contention candidates can be applied to the RDA. The RDA detects those contention candidates that are repeated across multiple executions by determining rhythmic patterns between contention candidates across multiple workload executions. For example, the results of the CIA may be supplied to the RDA, which computes correlation values between contention candidates of the first workload and contention candidates from a second workload execution. The RDA may iteratively compute correlation values between contention candidates of first and second workloads until a currently computed correlation value is less than a preceding correlation value. Once the condition is met, the contention candidates of the first and second workloads used to compute the preceding correlation value may be stored as a rhythmic pattern data set. The rhythmic pattern data set can be considered a contention and the execution environment information corresponding to the contention candidates of the rhythmic pattern data set (e.g., and related resources and events) are likewise correlated and stored.

The mediation module may analyze the execution environment information (for example, configurations of the distributed object store) associated with the rhythmic pattern data set to determine a root cause and provide configuration recommendations that can resolve the root cause. That is, for example, the mediation module can determine a configuration of the distributed object store that optimizes performance in executing subsequent workloads of the ML pipeline by mitigating the detected contentions. In an example, the reconciliatory engine may provide the determined configuration to a user as a recommendation and the user may assent to the deployment thereof. Upon receiving the assentation, the determined configuration can be deployed on the distributed object store for subsequent runs for optimum performance. In another example, the determined configuration can be automatically deployed without user assentation.

The examples disclosed herein provide various non-limiting advantages over conventional approaches. For example, one approach utilized predicated pushdown, which encompasses moving evaluation of a condition in a query of an ML pipeline closer to the location where the data is stored, traditionally used in database optimization. The examples disclosed herein leverages a mediation approach that can be applied to ML pipeline and storage-compute workloads generically, with an effective amicable resolution of possible contentions that is not available in the predicated pushdown approach.

Another conventional approach used in intent-based networking primarily focused on a concept that aims to apply a level of intelligence and intended state to replace the manual processes of configuring networks and reacting to network issues. The examples disclosed herein provide useful, procedural and user-assented decisions that address the replacement of manual processes along with the possibility of utilizing the solution in both reactive (e.g., failures) and proactive mode. Furthermore, the examples disclosed herein provide a contention identification and resolution mechanism that is not provided in the conventional intent-based approaches.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

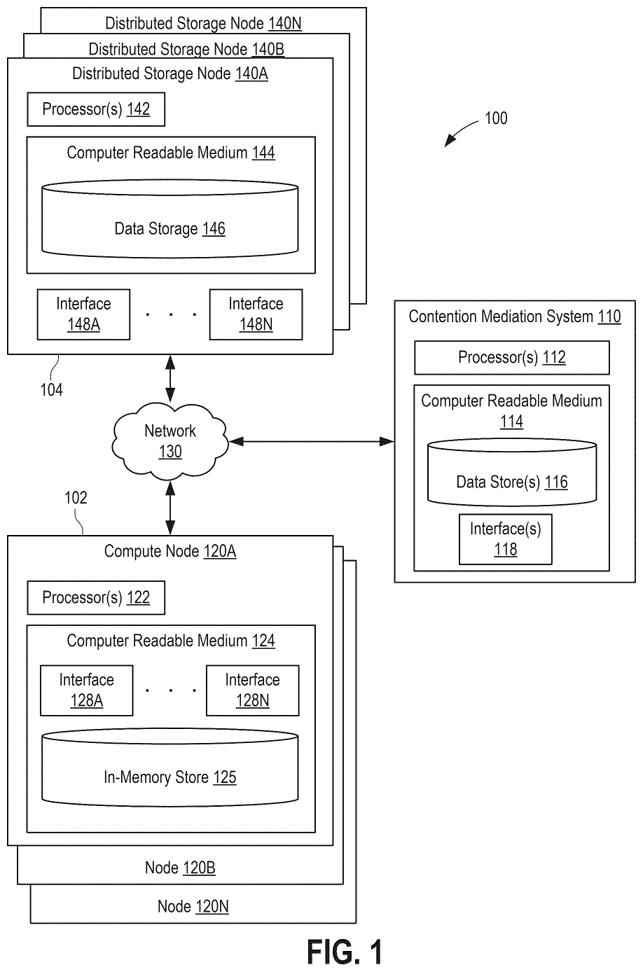

FIG. 1 depicts a schematic block diagram of a distributed environment 100 (also referred to as a distributed system) including a contention mediation system 110, in accordance with implementations of the disclosure. FIG. 1 illustrates an example of a distributed environment 100 in which workloads of an ML pipeline can be executed. The distributed environment 100 includes a compute infrastructure 102 that runs applications for executing the ML pipeline connected to distributed storage system 104. The contention mediation system 110 may be provided as a liminal node between the compute infrastructure 102 and the distributed storage system 104 via the network 130. The contention mediation system 110 may be configured to mediate data access (e.g., I/O operations) contentions on the distributed storage system 104 that may occur while the compute infrastructure 102 executes a workload. The contention mediation system 110 can also reconfigure the distributed storage system 104 for executing subsequent workloads.

As alluded to above, environment 100 may comprise compute infrastructure 102 in communication with a distributed storage system 104 via network 130. The compute infrastructure 102, in the example of FIG. 1, includes a plurality of compute nodes 120A-N (collectively referred to herein as “compute nodes 120” in the plural or “compute node 120” in the singular) with compute node 120A provided as an illustrative example of each compute node 120. In examples, the applications executing the workloads of the ML pipelines can be distributed amongst the compute nodes 120 and can be referred to as distributed applications. Distributed storage system 104 may be distributed across a plurality of distributed storage nodes, which are illustrated in this example as distributed storage nodes 140A-140N (collectively referred to herein as “distributed storage nodes 140” in the plural or “distributed storage node 140” in the singular) with distributed storage node 140A provided as an illustrative example of each storage node. Compute nodes 120, distributed storage nodes 140, and contention mediation system 110 may each comprise one or more processors and computer readable medium. Such computer readable media may comprise one or more functions, as discussed herein. As an example of each compute node 120, compute node 120A is shown having a processor 122 and computer readable medium 124. As an example of each distributed storage node 140, node 140A is shown having a processor 142 and computer readable medium 144. Likewise, contention mediation system 110 is shown having processor 112 and computer readable medium 114

Processor(s) 112, 122 and/or 142 may each represent one or more CPUs, GPUs, graph semiconductor-based microprocessors, and/or other hardware devices suitable for retrieval and execution of instructions stored in computer readable medium 114, 124 and/or 144. Processor(s) 112, 122 and/or 124 may each fetch, decode, and execute instructions to control processes or operations for optimizing the system during run-time. As an alternative or in addition to retrieving and executing instructions, processor(s) 112, 142 and/or 122 may each include one or more electronic circuits that include electronic components for performing the functionality of one or more instructions, such as a field programmable gate array (FPGA), application specific integrated circuit (ASIC), or other electronic circuits. As used herein, for convenience, the various instructions may be described as performing an operation, when, in fact, the various instructions program processor(s) 112, 122 and/or 142 to perform the operation. Similarly, where a computing device is disclosed as performing an operation, in fact the computing device's associated processor(s) perform the operation upon execution of associated instructions.

Computer readable medium 114, 124 and/or 144 may each comprise a random access memory (RAM), cache, and/or other dynamic storage devices, coupled to a bus for storing information and instructions to be executed by an associated processor(s) 112, 122 and/or 142. Computer readable medium 114, 124 and/or 144 also may each be used for storing temporary variables or other intermediate information during execution of instructions to be executed by an associated processor(s) 112, 122 and/or 142. Such instructions, when stored in storage media accessible to an associated processor(s) 112, 122 and/or 142, render contention mediation system 110, compute nodes 120 and/or distributed storage nodes 140 into special-purpose machines that are customized to perform the operations specified in the instructions.

In addition, computer readable medium 114, 124 and/or 144 may each comprise an electronic, magnetic, optical, or other physical storage device that contains or stores executable instructions. Thus, computer readable medium 114, 124 and/or 144 may each comprise, for example, Random Access Memory (RAM), dynamic RAM (DRAM), non-volatile RAM (NVRAM), an Electrically Erasable Programmable Read-Only Memory (EEPROM), a storage device, an optical disc, persistent memory and the like. In an illustrative example, computer readable medium 124 may comprise RAM and/or DRAM for volatile storage of data, while computer readable medium 144 comprises memory capable of providing RAM like access in a non-volatile infrastructure. As described in detail below, computer readable medium (media) 124 and/or 144 can be encoded with executable instructions.

In an example implementation, computer readable medium 124 comprises an in-memory store 125. The in-memory store 125 can function to store variables, data, or other information accessed and/or generated during an executed workload using volatile memory, such as DRAM and/or RAM. In an example implementation, in-memory store 125 can function as in-memory key-value (or object) data store. The in-memory store 125 may be associated with one or more data access interfaces, illustratively depicted as a plurality of data access interfaces 128A-128N (collectively referred to herein as “data access interfaces 128” in the plural or “data access interface 128” in the singular). The data access interfaces 128 may be executed for I/O operations, such as read/write operations. In an example implementation, data access interfaces 128 can be used for a number of data types (e.g., objects, blobs, custom training transformed data, data slices and so on) and data sizes (e.g., from MiB to PiB and intermediary sizes therebetween). In some implementations, the data types can be custom objects (e.g., data plus metadata), which can be ML pipeline transformed elements that will be used for other pipeline elements like training. The disparate data access interfaces 128 can be exposed for utilization by processor(s) 122 in accessing data stored in in-memory store 125 for executing instructions stored in computer readable medium 124. While the forgoing description is provided with respect to compute node 120A, each node 120 may comprise computer readable medium that is similarly suited to offer the same or similar functionality.

In the illustrative example of FIG. 1, computer readable medium 144 comprises a data storage 146. Data storage 146 can function to store variables, data, or other information accessed and/or generated during an executed workload. In an example implementation, data storage 146 can function to store key-value (or object) data. The data storage 146 may be associated with one or more data access interfaces, illustratively depicted as a plurality of data access interfaces 148A-148N (collectively referred to herein as “data access interfaces 148” in the plural or “data access interface 148” in the singular). In a case where distributed storage system 104 is implemented as DAOS, data access interfaces can include, but are not limited to, a object API, a distributed file system (DFS) API, through a pythonic API (e.g., pyDAOS), and so on. In an example implementation, data access interfaces 148 provide for interfacing compute nodes 120 to the underlying data storage 146. For example, I/O operations that read data from the underlying data storage 146 and/or write data to the underlying data storage 146 as part of a workload executed by the compute nodes 120, such as data pertaining to various phases of an ML pipeline, can be performed over data access interfaces 148. While the examples herein are described with reference to distributed storage system 104 implemented as a DAOS system, other example platforms can be used, such as but not limited to, VAST data storage, WEKA storage, and so on.

Contention mediation system 110 may include one or more data store(s) 116, which may be operatively coupled to the processor(s) 112. The data store(s) 116 may be, in some examples, an electronic data structure such as a database that can be stored in the computer readable medium 114 or another memory and that is configured with routines that can be executed by the processor(s) 112 for analyzing stored data, providing stored data, organizing stored data, and so on. In examples, the data store(s) 116 stores data used or generated by executing various functions of the contention mediation system 110. In some examples, the data store(s) 116 may include memory buffers that may temporarily hold data for executing the various functions of the contention mediation system 110.

Contention mediation system 110 may also include one or more data access interfaces 118 that can be utilized to obtain or otherwise read data from the compute infrastructure 102 and/or the distributed storage system 104. For example, the data access interface(s) 118 can provide for interfacing the contention mediation system 110 with one or more compute nodes 120 and/or one or more distributed storage nodes 140 to obtain underlying data related to executions of workloads. In examples, the data access interface(s) 118 may be exposed for utilization by processor(s) 112 in obtaining telemetry data related to executions of workloads on the compute nodes 120 and/or distributed storage nodes 140. The telemetry data may include performance metrics related to the execution of workloads and execution environment information related to the execution of workloads on the distributed storage system 104 and/or compute infrastructure 102. In examples, the telemetry data may be obtained as time series data comprising data points and timestamps of points in time at which the data point was obtained. In examples, the data access interface(s) 118 may be provided as one or more APIs for interfacing with the other components of the environment 100.

Contention mediation system 110 can be configured to optimize utilization of data access interfaces for I/O operations on the distributed storage system 104 while executing a workload by the compute infrastructure 102, for example, by mediating contentious I/O operations on the distributed storage system 104 that occur while executing a workload. For example, one or more compute nodes 120 may attempt to perform I/O operations on the distributed storage platform that may be contentious with other I/O operations by the same compute nodes 120 and/or other compute nodes 120. The contention mediation system 110 may comprise instructions stored in the computer readable medium 114 that, when executed by the processor(s) 112 cause the contention mediation system 110 to obtain telemetry data, including performance metrics, from the distributed storage system 104 related to the execution of a workload via data access interface(s) 118. The instructions, when executed by the processor(s) 112, may cause the contention mediation system 110 to identify portions (e.g., tasks or operations of the workload) of the execution as contention candidates based on performance drops identified in the performance metrics. The instructions, when executed by the processor(s) 112, may cause the contention mediation system 110 to detect contentions by correlating the identified contention candidates with contention candidates identified from a prior workload execution, for example, prior contention candidates stored in data store(s) 116. The contention mediation system 110 may execute instructions to determine a configuration of the distributed storage system 104 that optimizes the execution of a subsequent workload execution by mitigating the detected contentions. The determined configuration may be deployed on the distributed storage system 104 by reconfiguring the distributed storage nodes 140 and data storage thereon (e.g., data storage 146) so to mitigate the detected contentions during execution of a subsequent workload. In some examples, the determined configuration may schedule tasks of the workload on the distributed storage nodes 140 so to mitigate and avoid these contentious events during the subsequent executions.

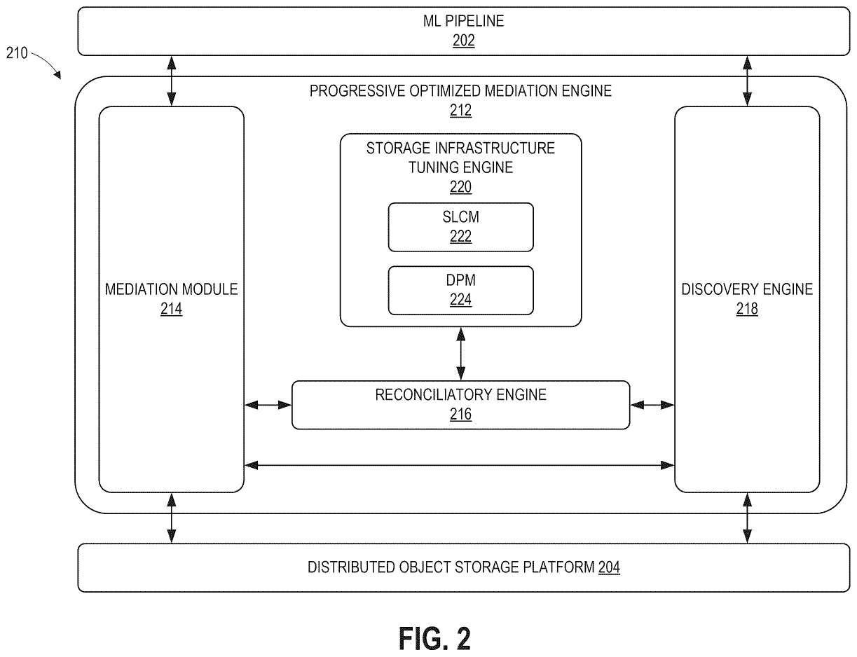

FIG. 2 illustrates an example contention mediation system 210, in accordance with examples of the present disclosure. The contention mediation system 210 may be a detailed example of the contention mediation system 110 of FIG. 1. As shown in FIG. 2, the contention mediation system is provided as a liminal node between an ML pipeline 202 having phases (e.g., applications) executed by a computation infrastructure (e.g., computation infrastructure 102) and a distributed object storage platform 204 (e.g., distributed storage system 104). Contention mediation system 210 can be configured to optimize utilization of the distributed object storage platform 204 while executing a workload of the ML pipeline 202, for example, by mediating contentious I/O operations occurring during the execution of workloads.

In the example of FIG. 2, the contention mediation system 210 comprises various modules and engines for executing the various functions of the contention mediation system 210. For example, the contention mediation system 210 may include Progressive Optimized Mediation Engine (POME) 212 stored to a memory (e.g., computer readable medium 114 of FIG. 1) as a set of instructions that, when executed by processor(s) (e.g., processor(s) 112 of FIG. 1), cause the processor(s) to perform the various functions of the POME 212 disclosed herein. As such, an engine may refer to, for example, computer-readable instructions that can be executed by processor(s). For example, the POME 212 may include instructions that, when executed by processor(s), cause the processor(s) to mediate and reconfigure a distributed object storage platform 204 for performing workloads of an ML pipeline 202. The POME 212 may, in some examples, mediate contentious operations and reconciliate bespoke configurations to the distributed object storage platform 204 based performance metrics related to the execution of the ML pipeline 202 to improve data access on the distributed object storage platform 204, as well as improve time to solution and consistency of computed outcomes.

The POME 212 may comprise various sub-components for executing dedicated functions. For example, the POME 212 may include a mediation module 214, a reconciliatory engine 216, a discovery engine 218, and a storage infrastructure tuning engine 220. As noted above, the term engine may refer to, for example, computer-readable instructions that can be executed by processor(s). Likewise, the term module may refer to, for example, a set of computer-readable instructions that can be executed by processor(s). In examples, the various modules and engines 214-218 may be stored in a memory (e.g., computer readable medium 114 of FIG. 1) as sets of instructions that, when executed by processor(s) (e.g., processor(s) 112 of FIG. 1), cause the processor(s) to perform the various dedication functions disclosed herein.

The discovery engine 218 may include instructions that, when executed, cause the contention mediation system 210 to gather telemetry data related to the execution of the ML pipeline 202. This information can include, but is not limited to, performance metrics, execution environment information, and other telemetry data. Execution environment information may include, but is not limited to, workload states, events and pipeline execution dependencies (e.g., software and library dependencies), and configuration information. The configuration information may include information descriptive of computation resources utilized to execute workloads, such as compute nodes providing compute power, utilized network bandwidth, memory capacity (e.g., number of storage nodes, including available storage capacity), storage I/O threads. The telemetry data may be provided as time-series data, for example, by associating information with times at which the information occurred. The performance metrics can include I/O characteristics, such as ML pipeline 202 execution touch points with the distributed object storage platform 204, such as I/O characteristics of instances at which compute nodes perform an I/O operation on distributed storage nodes of the distributed object storage platform 204. Thus, the discovery engine 218 can collect information related to compute, storage and network utilization and overall performance of execution of the ML pipeline 202.

I/O characteristics may include, but are not limited to a number of compute processing units (e.g., number of CPUs, number of GPU, and the like) utilized for each workload (or each task of a workload), a kind of I/O generated at the distributed object storage (e.g., a data block size, such as 4 KB, 8 KB, 16 KB, 4 MB, and so on), a total number of processors utilized for the I/O operations. I/O characteristics may also include a periodicity and/or a plurality of I/O operations of various sizes with different interfaces that may form a pattern, for example, determination that read operations are more numerous than write operations.

In an example, the discovery engine 218 may interface with a user interface front-end (UI executed on a front-end system) through which a user can enumerate settings and default configuration information. For example, a user can input enumeration values corresponding to certain setting (on compute or storage configurations), types of I/O, etc. As an example using DAOS as a distributed object storage platform 204 a user may input a command “Enum storage_option {single rank, dual rank, distributed, system decided}.” In this case, by selecting any one of the enumeration values, the user can specify where data is to be placed for use during the execution of the ML pipeline 202. The user can also select to leave dynamic placement decisions to POME 212, in which case POME 212 may be executed to select optimal placement locations based on analysis by the other modules of POME 212.

Discovery engine 218 may be executed to gather information related to the execution of the ML pipeline 202 by tracking various markers the ML pipeline 202 during execution of the workload. These markers may be included as part of the telemetry data captured during its runtime. In the context of telemetry data, “markers” (also known as “frame sync words” or “patterns”) may refer to specific bit patterns or headers that indicate the start and end of data frames, ensuring accurate data alignment and synchronization.

In some examples, discovery engine 218 may be executed to use instrumentations to capture decision-making data related to the execution of the ML pipeline 202. For example, the discovery engine 218 may be executed to capture hardware and software utilization information in the execution environment. Discovery engine 218 may monitor compute capability present on the distributed storage nodes and can the distributed storage nodes to obtain details about computation resource utilization thereon. As an example, in an environment where DAOS is leveraged as the distributed object storage platform 204, the information captured by the discovery engine 218 may include, but is not limited to, number of DAOS nodes, number of DAOS engines, number of DAOS targets, number of additional offload service threads per DAOS engine, and Non-Uniform Memory Access (NUMA) node on which DAOS engines can be pinned.

The mediation module 214 may include instructions that, when executed, cause the contention mediation system 210 to facilitate (e.g., control) gathering of information between ML pipeline 202 and the distributed object storage platform 204 related to the execution of the ML pipeline 202, identify possible contentious points (e.g., operations) in the execution, and provide solutions to mitigate the contentious points. For example, the mediation module 214 may facilitate gathering of certain information related to the execution of the ML pipeline by the discovery engine 218. The information related to the execution of the ML pipeline 202 can be retained, for example, in data store(s) 116 for subsequent analysis. The mediation module 214 may also obtain configurations and features of the distributed object storage platform 204 by interfacing with the distributed object storage platform 204, for example, by utilizing data access interface(s) 118 of FIG. 1.

The mediation module 214 may also include instructions that, when executed, cause the contention mediation system 210 to detect contentious operations of the ML pipeline 202 from the gathered information. For example, the mediation module 214 may include instructions that can be executed to isolate portions of the ML pipeline 202 as contention candidates. For example, mediation module 214 may execute one or more algorithms to smoothen out unwanted undulations in time-series performance metrics and apply performance deviation criteria to detect drops in performance followed by extended periods of steady performance (referred to herein as performance landings or landings). The mediation module 214 may consider data points of the gathered information corresponding to the detected performance drop and landing as the contention candidates. Performance deviation criteria, in examples, may include a threshold degradation, a threshold deviation range, and a threshold period of time.

Performance metrics can be provided as a set of performance data points having a performance metric value and time. In this case, the mediation module 214 may detect a drop in performance by applying the threshold degradation to neighboring performance data points. For example, if a change in performance between neighboring performance data points is less than the threshold degradation, the mediation module 214 may consider the performance metric as a drop in performance. The mediation module 214 may detect a performance landing from a set of neighboring performance data points following the detected performance drop. For example, if the deviation between performance metric values of a set of neighboring performance data points is within the threshold deviation range, the mediation module 214 may considered the set of neighboring performance data points as a performance landing. The mediation module 214 can then determine that the performance landing occurs over an extended or long period time by determining that the period of time corresponding to the detected performance drop and performance landing (e.g., the set of neighboring performance data points) exceeds the threshold period of time. The performance data points satisfying the above performance deviation criteria can be considered a contention candidate that occurred during the execution of a workload.

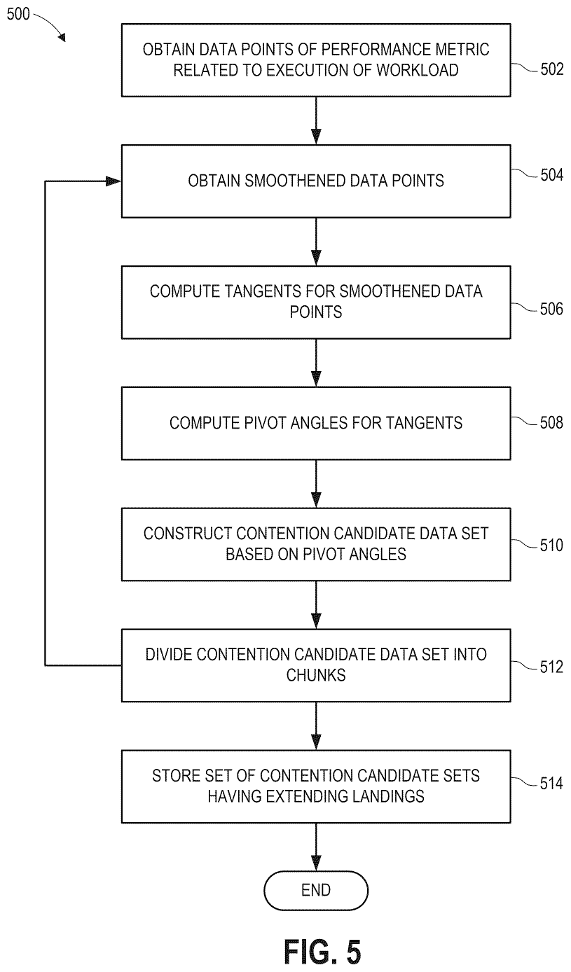

The execution environment information, such as resources, and configuration information, corresponding to the identified performance drops can be retained for subsequent analysis. Mediation module 214 may store the performance data points corresponding to the performance drop to data store(s) (e.g., data store(s) 116) as a set of contention candidates, which may include subsets of performance metric values, timestamps, and related execution environment information. In examples, the one or more algorithms executed by the mediation module 214 may include a CIA that smoothens and identifies candidate contentions. Additional details of example algorithm(s) for identifying contention candidates are provided below in connection with FIGS. 5-8B.

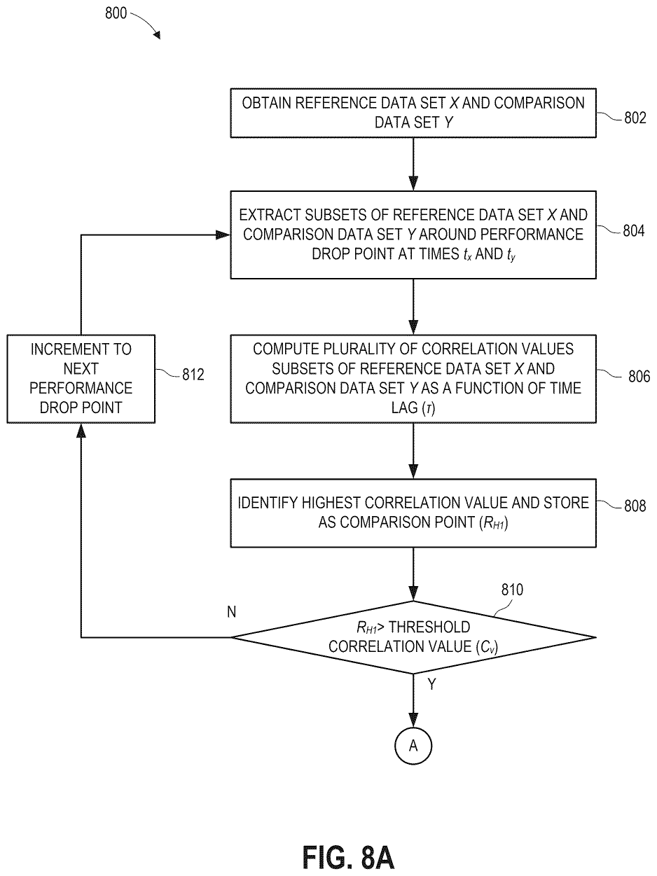

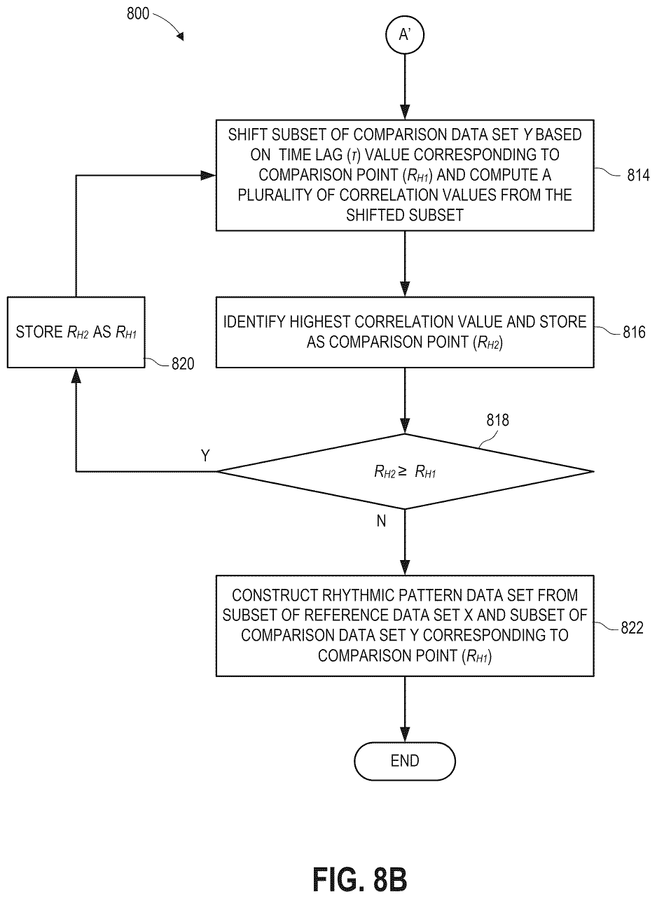

The mediation module 214 may also be executed to detect rhythmic patterns of contention candidates by comparing contention candidates across multiple executions of the ML pipeline 202. For example, mediation module 214 may detect which of the contention candidates identified above are repeated candidates by determining rhythmic patterns across workloads. The mediation module 214 may execute one or more algorithms to compute correlation values between contention candidates from different workload executions. The mediation module 214 may iteratively compute correlation values between the contention candidates of workload executions until a current instance of computed correlation is less than a preceding instance. Once this condition is met, the contention candidates of the multiple workloads used to compute the preceding correlation value may be stored to data store(s) as a rhythmic pattern data set. The rhythmic pattern data set may be considered a contention and the mediation module 214 may correlate and store execution environment information descriptive of a configuration of the distributed object storage platform 204 corresponding to the contention candidates of the rhythmic pattern data set (e.g., and related resources and events). Additional details of example algorithm(s) for detecting a contention are provided below in connection with FIGS. 8A and 8B.

The mediation module 214 may also be executed to analyze the correlated execution environment information to determine a root cause and provide configuration options aimed to resolve the root cause as an output of this algorithm. That is, for example, the mediation module 214 may determine configurations correlated with detected contention and the configuration may be considered a root cause of detected contention. The mediation module 214 may determine an optimal configuration of the distributed object storage platform 204 that optimizes performance in executing a subsequent workload of the ML pipeline by mitigating the detected contention points.

The mediation module 214 may interface with the storage infrastructure tuning engine 220 to identify overprovisioned compute nodes and distributed storage nodes along the ML pipeline 202 to locate the root cause and identify distributed storage nodes with idle compute resources and distributed storage nodes along the ML pipeline 202 as candidates to resolve the root cause. In examples, the storage infrastructure tuning engine 220 may include a storage local compute module (SLCM) 222 and a data placement module (DPM) 224 that can be leveraged by the mediation module 214 to provide the above functionality.

The SLCM 222 may contain instructions that, when executed, identifies overprovisioned and idle distributed storage nodes in the execution of a workload, along with pipeline execution dependencies, such as software and libraries. SLCM 222 may be able to seed portions of ML pipeline 202 to distributed storage nodes of the distributed object storage platform 204. In one example, the SLCM 222 may be executed to seed portions of the ML pipeline to a bare-metal storage system, while in another example the SLCM 222 may be able to deploy containers on the identified distributed storage nodes.

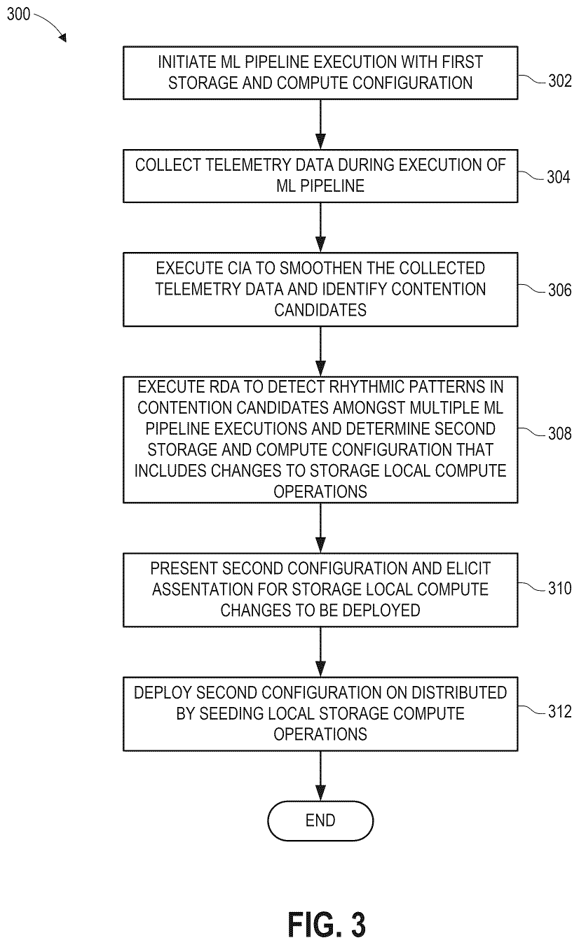

In examples, SLCM 222 may be executed to monitor computation resources utilized in the execution environment, such as compute nodes and/or distributed storage nodes. In an example, the data can be gathered by the discovery engine 218 by analyzing configuration files of the distributed object storage platform 204. As an example, DAOS nodes may have a configuration file ‘daos_server.yml’, which provides details of the configured resources for that DAOS node. Using the gathered data, SLCM 222 can be executed to derive available computation resources, such as available CPU cores on the compute infrastructure and an amount of available memory on the distributed object storage platform 204. This information can be provided as inputs to the SLCM 222 along with the detected contentions from the mediation module 214, which the SLCM 222 may evaluate along with the execution environment to optimize the execution of the ML pipeline 202. Additional details of example operations of the SLCM 222 are provided below in connection with FIG. 3.

FIG. 3 is a flow chart of an example optimized storage local compute flow 300, in accordance with an example of the present disclosure. The optimized storage local compute flow 300 (herein referred to as flow 300) may be implemented as instructions, for example, stored in a memory, that when executed by one or more processors perform one or more operations of flow 300. For example, flow 300 may be implemented as instructions stored in computer readable medium 114 of FIG. 1, that when executed by processor(s) 112 perform one or more operations of flow 300. Flow 300 will be described with reference to the contention mediation system 210 of FIG. 2. However, examples herein are not intended to be limited to contention mediation system 210.

As alluded to above, contention mediation system 210 can provide options for using unused or overprovisioned storage nodes on the distributed storage nodes to run workloads of ML pipeline 202. FIG. 3 illustrates an example functional flow between various engines and modules of contention mediation system 210 that can be executed to ensure an optimal execution environment that is configured for executing optimal node local compute. The information collected by contention mediation system 210 can be used for provenance by the modules and engines that constitute the POME 212. The output of these modules and engines can provide insights into the performance of the ML pipeline 202. Furthermore, the outputs may be used in deciding where related data can be stored in the distributed object storage platform 204 for maximum efficiency, as well as how the workloads can be scheduled in data localities to overcome performance drops. Thus, flow 300 can be leveraged to provide a faster and smoother experience for the user under load scenarios.

At block 302, an execution of ML pipeline 202 may be initiated using a first configuration of the distributed object storage platform 204 and the compute infrastructure. In examples, a user may initiate such execution using specified configurations. In some examples, the first configuration may be a default configuration that represents a sequentially first (e.g., initial) execution of the ML pipeline 202. In other examples, the first configuration may refer to a current configuration.

At block 304, telemetry data can be collected during the execution of the ML pipeline according to the first configuration. In examples, block 304 may be executed by discovery engine 218 according to control by the mediation module 214, as described above. Block 304 may include gathering telemetry data, such as performance metrics and execution environment information.

At block 306, a CIA can be executed that smoothens the data collected at block 304 and identifies contention candidates along the ML pipeline 202 as possible points for performance optimization. In examples, block 306 may be executed by the mediation module 214, as described above. For example, contention candidates can be identified from performance metrics collected with the telemetry data by applying performance deviation criteria to detect drops in performance followed by extended periods of steady performance.

At block 308, an RDA can be executed that detects rhythmic patterns in the contention candidates identified at block 306 within and amongst various executions of the ML pipeline 202. In examples, block 308 may be executed by the mediation module 214, as described above. For example, rhythmic patterns can be identified by comparing contention candidates across multiple executions of the ML pipeline 202. The multiple executions may be executions that are successive in time (e.g., one follows another without any intermediate executions) or simply prior in time (e.g., one follows another, but one or more executions may occur therebetween). The identified rhythmic patterns can be considered a contention and the mediation module 214 may correlate and store execution environment information corresponding to the rhythmic pattern (e.g., and related resources and events).

In examples, block 308 may include determining a second configuration of the distributed object storage platform 204 and compute infrastructure. For example, the mediation module 214 may analyze the execution environment information correlated with the detected contention to determine a root cause and construct a configuration aimed to mitigate the contention by resolving the root cause. The constructed configuration can be as the second configuration. The root cause, in this example, may be correlated with a local compute operation at one or more distributed storage nodes of the distributed object storage platform 204. In this case, the second configuration may include changes to the storage local compute operations to be deployed at one or more distributed storage nodes.

At block 310, the second configuration can be presented to a user as a recommendation to elicit assentation by the user for deployment of the second configuration for a subsequent execution of the ML pipeline. For example, reconciliatory engine 216 may provide the second configuration as a recommendation via a user interface, which the user may input agreement therewith. As noted above, the second configuration can include changes in storage local compute operations that can be deployed on storage nodes. Based on the assentation (e.g., in response to), the second configuration can be deployed to change or otherwise transition the first configuration of the distributed object storage platform 204 and compute infrastructure to the second configuration.

At block 312, the second configuration can be deployed on to the distributed object storage platform 204 and compute infrastructure by seeding the local storage compute operations on one or more distributed storage nodes. For example, the SLCM 222 may track the distributed object storage platform, along with computation resource requirements of the storage compute construct. The SLCM 222 may evaluate the distributed storage nodes for local storage compute execution environment. Based on the evaluation, the SLCM 222 may run the local storage compute on bare-metal storage system or through seeding containers within the execution environment. As a result of block 312, an optimized storage local compute environment can be configured for utilization during a subsequent workload of the ML pipeline 202.

As an illustrative example, consider an execution environment used to execute a number of tasks (e.g., operations) T defining a workload of the ML pipeline 202. In this example, the computation infrastructure may include compute nodes C₁ . . . C₂₀ and the distributed object storage platform 204 may include distributed storage nodes S₁ . . . S₁₀. The tasks T may be executed on a first configuration of the execution environment and telemetry data related to the execution of the tasks T may be collected according to block 304 of FIG. 3. Blocks 306 and 308 may be executed to detect rhythmic patterns of performance drops from contention candidates. The SLCM 222 may receive the rhythmic patterns as a rhythmic pattern data set comprising performance data points of extended periods of performance drops across the multiple executions of the tasks T. The performance data points of the rhythmic pattern data set may include timestamps at which performance metric values occurred.

The SLCM 222 may also obtain execution environment information related to the execution of the tasks T collected by the discovery engine 218 (e.g., block 304). The SLCM 222 may correlate the execution environment information related to the execution of the tasks T to the performance data points of the rhythmic pattern data set according to timestamps and recognize root causes of the contentions. For example, SLCM 222 may detect similar configurations in the execution environment information between the multiple executions and determine that the similar configurations represent a root cause of the performance drop. For example, execution of a task T may be represented as a tokenization of the performance in executing a portion of an ML pipeline on a configuration. As an illustrative example, during execution of first workload of the ML pipeline, the task T may executed on a configuration C1 and returns a performance P1. The tokenization of performance P1 can include the task T and configuration C1. During execution of a second workload, task T can be executed on a configuration C2 and returns performance P2. The tokenization of performance P2 can include the task T and configuration C2. The tokenizations can be compared using known similarity techniques to determine that the configurations C1 and C2 are similar. A root cause of a drop in performance between performance P1 and performance P2 can then be associated with similar configurations. p Based on the root cause, SLCM 222 can make scheduling decisions to schedule tasks T on compute nodes C₁ . . . C₂₀ and/or distributed storage nodes S₁ . . . S₁₀ to mitigate the root causes on future executions. For example, consider that SLCM 222 detects, based on rhythmic pattern data set and related execution environment information as inputs, a sudden surge of workload data movement between distributed storage nodes S₆ and S₇ and compute nodes C₁₅ and C₁₆ on every third execution or during a particular day of the week, when tasks T₁ and T₂ are executed. In this example, the sudden surge can lead to a network overload in distributed storage nodes S₆ and S₇ and compute nodes C₁₅ and C₁₆ during execution of task tasks T₁ and T₂, resulting in compute nodes C₁₀ . . . C₁₄ being unable to execute their respective tasks.

In this case, SLCM 222 may use information gathered by the discovery engine 218 (e.g., block 304) to figure out the compute resource requirements of the task T₁ and T₂ running on compute nodes C₁₅ and C₁₆. SLCM 222 may also discover that distributed storage nodes S₆ and S₇ have overprovisioned resources available that can execute the tasks T₁ and T₂. In this example, SLCM 222 may progressively schedule the tasks T₁ and T₂ on distributed storage nodes S₆ and S₇.

For example, tasks T₁ and T₂ may be run directly on the distributed storage nodes S₆ and S₇, In this case, the library requirements for the tasks T₁ and T₂ may be satisfied by distributed storage nodes S₆ and S₇. The SLCM 222 may evaluate the distributed storage nodes S₆ and S₇ to check that their respective dependencies can satisfy the library requirements. If the SLCM 222 confirms the library requirements can be satisfied, the SLCM 222 may seed the tasks T₁ and T₂ in the distributed storage nodes S₆ and S₇ for use during a subsequent execution.

In another example, the SLCM 222 may be configured to spawn a docker container on distributed storage nodes S₆ and S₇ with the dependent libraries required by the tasks T₁ and T₂. Docker containers can be self-contained and may not affect the host environment software dependencies. Thus, concerns of possible library corruption on the distributed storage nodes can be minimized, and a part of the ML pipeline 202 can take advantage of the free compute resources on the distributed storage nodes S₆ and S_{7,} running the ML pipeline in data locality.

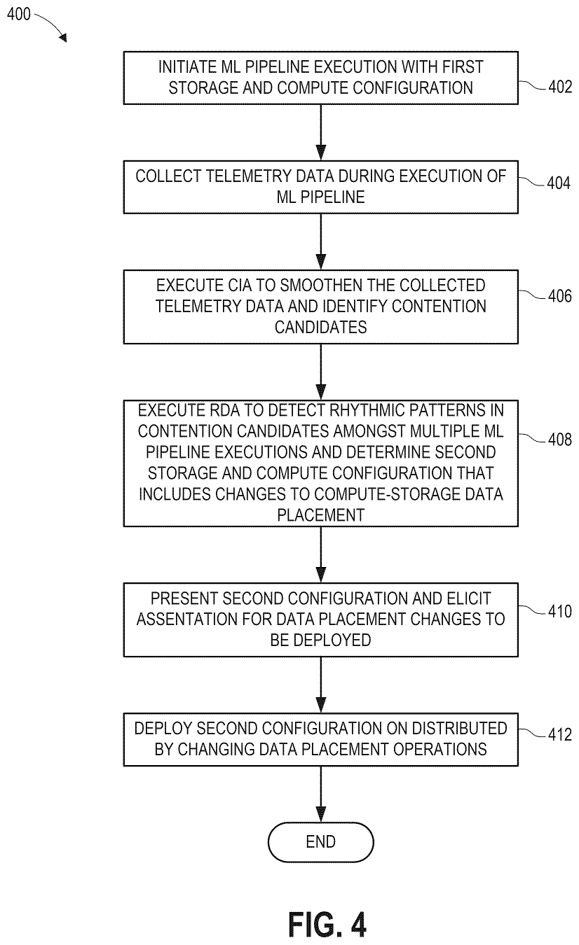

Referring back to FIG. 2, the DPM 224 may contain instructions that, when executed, identifies one or more distributed storage nodes on which data can be distributed for the ML pipeline 202. In examples, the DPM 224 may be executed to carve out storage space in the distributed object storage platform 204 where data of the ML pipeline 202 can be stored and accessed across the distributed object storage platform where there is idle compute. That is, for example, the DPM 224 can be executed for storing data in available storage space for the purpose of optimized data access and compute of the ML pipeline 202. Additional details of example operations of the DPM 224 are provided below in connection with FIG. 4.

The reconciliatory engine 216 may include instructions that, when executed, cause the contention mediation system 210 to deploy configurations for mitigating contentious operations in the ML pipeline 202. The configurations may be determined by the mediation module 214 in tandem with the storage infrastructure tuning engine 220 to mitigate root causes of detected contentions by providing an optimized configuration for executing a subsequent workload of the ML pipeline 202. For example, reconciliatory engine 216 may include instructions that, when executed, provides the determined configuration to a user as a recommendation via the user interface. The user may agree with the recommendation and assent to deployment into the execution environment. Upon receiving the assentation, the reconciliatory engine 216 may deploy the determined configuration on the distributed object storage platform 204 for subsequent workloads. In another example, reconciliatory engine 216 may automatically deploy the determined configuration without user assentation. In either case, the reconciliatory engine 216 may interface with the DPM 224 and/or SLCM 222, which work in conjunction to elicit optimum performance during exigency of storage-compute resource and deploy the determined configuration.

FIG. 4 is a flow chart of an example optimized data placement flow 400, in accordance with an example of the present disclosure. The optimized data placement flow 400 (herein referred to as flow 400) may be implemented as instructions, for example, stored in a memory, that when executed by one or more processors perform one or more operations of flow 400. For example, flow 400 may be implemented as instructions stored in computer readable medium 114 of FIG. 1, that when executed by processor(s) 112 perform one or more operations of flow 400. Flow 400 will be described with reference to the contention mediation system 210 of FIG. 2. However, examples herein are not intended to be limited to contention mediation system 210. Blocks 402 through 406 may be substantially similar to blocks 302-306 described above, and as such the description above applies hereto.

At block 408, similar to block 308 of FIG. 3, an RDA can be executed that detects rhythmic patterns in contention candidates identified at block 406 within and amongst various executions of the ML pipeline 202.

Block 408 may also include determining a second configuration of the distributed object storage platform 204 and compute infrastructure related to data placement of the ML pipeline 202. For example, the mediation module 214 may analyze the execution environment information correlated with the detected contention to determine a root cause and construct a configuration aimed to mitigate the contention by resolving the root cause. The constructed configuration can be referred to as the second configuration. The root cause, in this example, may be correlated with data access and storage operations at one or more distributed storage nodes of the distributed object storage platform 204. In this case, the second configuration may include changes to data placement within amongst the distributed storage nodes.

At block 410, the second configuration can be presented to a user as a recommendation to elicit assentation by the user for deployment of the second configuration for a subsequent execution of the ML pipeline 2022. For example, reconciliatory engine 216 may provide the second configuration as a recommendation via a user interface, which the user may input agreement therewith. As noted above, the second configuration can include changes in data placement. Based on the assentation (e.g., in response to), the second configuration can be deployed to change or otherwise transition the first configuration of the distributed object storage platform 204 and compute infrastructure to the second configuration to provide changes in data placement for data access operations of the ML pipeline 202.

At block 412, the second configuration can be deployed on to the distributed object storage platform 204 and compute infrastructure by changing data placement operations, so to store data at locations that optimizes the data storage and memory resource utilization. For example, the DPM 224 may track the distributed object storage platform 204 to determine overprovisioned memory and underutilized memory on distributed storage nodes. The DPM 224 may evaluate the memory capacity and create new storage volumes and/or utilize existing, underutilized storage volumes to place data related to the execution of the ML pipeline in a manner the optimizes the memory capacity.

As an illustrative example, initial data placement into distributed storage nodes S₁ . . . S₂₀ can be defined from user inputs. Rhythmic pattern data sets detected through executing the CIA and RDA (e.g., blocks 406 and 408) can be used in making data placement decision across the distributed object storage platform 204. The information related to the execution of the ML pipeline 202 (e.g., gathered by discovery engines 218 at block 404) can include type of data accessed, spread of this data across distributed storage nodes S₁ . . . S₂₀, how many users accessed the data, which compute nodes are accessing the data, etc., which can be provided as inputs to DPM 224. This data may also show whether the actual storage usage and data access operations executed during the ML pipeline 202 are in tune with the initial data placement.

In an example, consider the distributed object store platform 204 comprises distributed storage nodes S₁ . . . S₂₀ assigned ranks r₁ . . . r₂₀. The rhythmic pattern data sets can be used to detect extended performance drops in data access stored across multiple ranks (r₁, r₂ . . . r₁₀) in distributed storage nodes S₁ . . . S₂₀. User inputs, in this example, related to the initial data placement on distributed storage nodes S₁ . . . S₂₀ can be listed, along with configuration information of compute nodes running tasks on the data. The DPM 224, using information gathered by the discovery engine 218, can obtain information on the number of CPU cores and amount of memory used to execute tasks on the data from the distributed storage nodes S₁ . . . S₂₀. Using the rhythmic pattern data sets from, the DPM 224 determines if executed tasks are part of performance drops spread across multiple executions.

Based on these inputs DPM 224 can check if the hardware requirements of the workload, which observed the performance drop, can be met by the available overprovisioned CPU cores and/or memory available in the distributed storage nodes S₁ . . . S₂₀. DPM 224 can use a storage size Sᵣ to determine if the data needs to be placed on a single distributed storage node or multiple distributed storage nodes. The value of Sᵣ can vary between storage environments depending on the desired implementation. For example, Sᵣ may be 1TB in an illustrative example. In an example, the DPM 224 checks if the data requirement for a particular phase or task of the workload is of a size that is less than or equal to Sᵣ and checks if the available compute on storage nodes, gathered by the discovery engine 218, can meet this requirement. If the DPM 224 locates such a storage node, the DPM 224 can decide to place the user's data for the particular phase or task on a single rank (e.g., such as r₁₀) in the distributed object storage platform 204. Thus, POME 212 can progressively analyze the execution environment and mediate between the successive executions to reach an optimized data placement.

If, however, the data requirement for a particular phase or task of the workload is greater than Sᵣ, the DPM 224 can uses multiple CPU cores and multiple distributed storage nodes. In this case, DPM 224 may not place the data on a single rank. Instead, using information the discovery engine 218, the DPM 224 may match the hardware requirement of the tasks or phases with overprovisioned compute resources over multiple distributed storage nodes S₁ . . . S₂₀. If the compute requirements are met by a set of storage nodes having ranks, for example, r₈ . . . r₁₂, DMP 224 may place user data on those distributed storage nodes.

In an example, the data placement on a specific set of distributed storage nodes can be done so that the SLCM 222 can take advantage of this placement and schedule tasks, as described above.

Furthermore, in one example, the data placement can be achieved by re-using already existent pools and containers on the selected distributed storage nodes. In another example, data placement can be achieved creating new pools and containers on selected distributed storage nodes using commands provided by the distributed object storage platform.

In some examples, rhythmic patterns may be detected for dissimilar portions of the ML pipeline 202. For example, rhythmic patterns may be located from performance metrics from multiple executions, but the execution environment information corresponding to the rhythmic patterns may differ (e.g., minimal overlap in similarity). In this case, the DPM 224, with reference to telemetry data gathered by the discovery engine 218, may check if the hardware requirements for these rhythmic patterns are similar. For example, similar configurations can be determined using tokenization of executions as described above in connection with SLCM 222. If hardware requirements are found to be similar and a distributed storage node or a set of distributed storage nodes satisfies the requirements, the DPM 224 can decide to place the data on those distributed storage nodes with available resources for optimal execution.

FIG. 5 is a flow chart of an example contention identification flow 500, in accordance with an example of the present disclosure. The contention identification flow 500 (herein referred to as flow 500) may be implemented as instructions, for example, stored in a memory, that when executed by one or more processors perform one or more operations of flow 500. For example, flow 500 may be implemented as instructions stored in computer readable medium 114 of FIG. 1, that when executed by processor(s) 112 perform one or more operations of flow 500. Flow 500 may be an example of a CIA that can be executed by the mediation module 214 of FIG. 2.

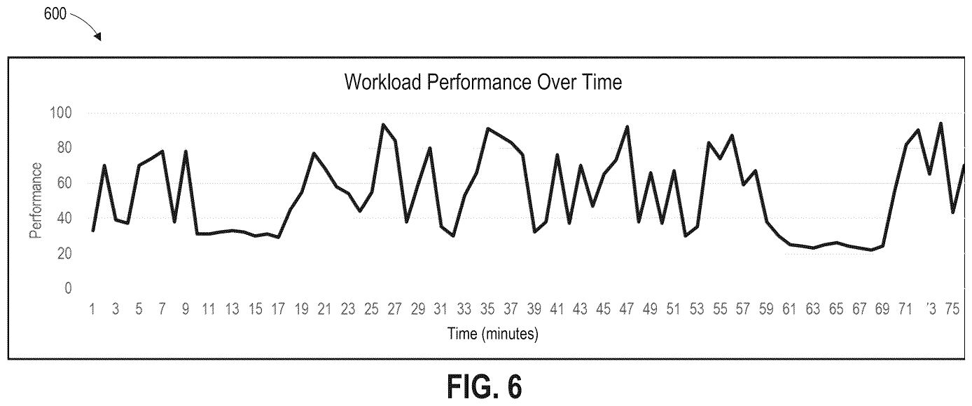

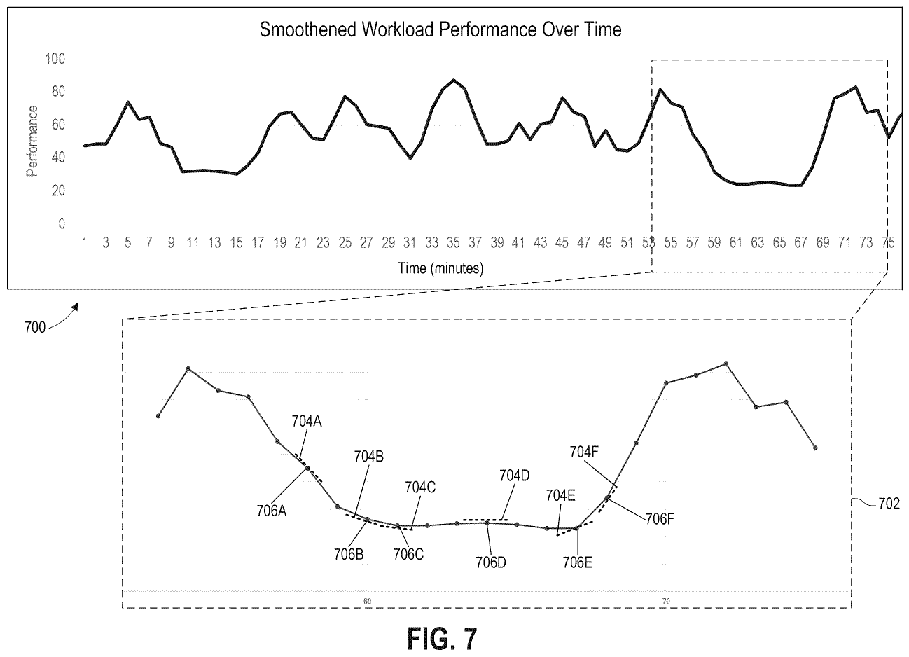

FIG. 5 will be described with reference to performance graphs shown in FIGS. 6 and 7. FIG. 6 illustrates an example performance graph 600 comprising performance data points of a performance metric related to the execution of a workload of an ML pipeline (e.g., ML pipeline 202 of FIG. 2). In the example of FIG. 6, the performance metric illustrated is an example I/O characteristic provide as a tokenization of the time, in seconds, to execute a task of the workload on a given number of CPUs. The number of CPUs used at each performance metric may represent a respective configuration used to obtain a respective performance (e.g., time to execute the task). The performance data points include performance metric values (e.g., value of the tokenization time) normalized to values ranging from 0 to 100 and are plotted as a function of time, in minutes, at which the performance metric was obtained. FIG. 7 illustrates an example performance graph 700 that is a result of smoothening the performance graph 600. FIG. 7 also illustrates a zoomed in region 702 of performance graph 700 that depicts an example performance drop containing performance data points of an example contention candidate.

As shown in performance graph 600, performance metrics can be predominated by dips and spikes when seen under normal circumstances. To eliminate these dips and spikes, while highlighting those relevant to the contention analysis, the examples herein may execute a smoothening algorithm, such as but not limited to a Moving Average (MA), to smoothen the performance metric. As noted above, performance graph 700 is an example of this smoothening algorithm. Tangents 704A-F can be obtained at certain smoothened data points 706A-706F, which can be used to find a degree of deviation created by spikes and dips from the smoothened performance data. Each smoothened data point may comprise a subset of the performance data point used to compete the smoothened data. For example, where a moving average is computed from three performance data points, the resulting smoothened data point corresponds to the respective three performance data points. Sudden drops in performance with an extended landing formation in the smoothened graph may represent a performance drop in the expected performance, which is of interest. Once these smoothened data points of interest, examples of contention candidates, are located the other information (e.g., execution environment information) related to the performance data points that constitute the smoothened data point of interest can be analyzed for root cause of the origin of these performance drops.

Turning to FIG. 5, a set of performance data points dₚ {d₁ . . . } related to execution of a workload can be obtained at block 502, which may be part of a larger set of performance points data points dₘ. Hence, a dataset may comprise of m such sets of performance data points dₚ. The performance data set dₘ may include performance metric values over time. For example, the performance graph 600 illustrates an example set of performance data dₚ over a 75 minute execution of a workload. At block 504, smoothened data points can be obtained from performance data points obtained at block 502. For example, a moving average can be obtained for each subsets of data points dₚ to obtain smoothened data points D_{M1} . . . D_{Mm}. The number of performance data points dₚ may be set as desired for a given application depending on the number of points desired for the moving average. Performance graph 700 illustrates an example of smoothened data points D_{M1} . . . D_{Mm}.

At block 506, tangents can be computed for the smoothened data points. For example, tangents can be computed, such that a tangent is obtained for each smoothened data point D_{M1} . . . D_{Mm} (e.g., t₁ . . . tₘ tangents). At block 508, pivot angles θ with respect to the horizontal (e.g., X-axis) can obtained for each tangent t₁ . . . tₘ providing θ₁ . . . θ_{m.} Tangents can be computed by calculating a slope between performance data points of a respective smoothened data point and the pivot angles can be obtained by applying an arctangent function to the slope. Zoomed in region 702 of performance graph 700 illustrates example tangents 704A-F computed for smoothened data points 706A-F. While only certain tangents are shown in FIG. 7, examples herein may compute tangents for each smoothened data point.

At block 510, a contention candidate data set dₓ can be constructed based on the pivot angles obtained at block 508. For example, the contention candidate data set dₓ can be constructed by populating the contention candidate data set with smoothened data points associated with negative pivot angels. Negative pivot angles may represent a drop or decrease in the performance metric. Thus, if a pivot angle is positive or zero, the flow 500 proceeds to the next pivot angle. If the pivot angle is negative, the moving average data point corresponding to the negative pivot angle can be stored to a contention candidate data set dₓ. For example, the data points from performance data set dₚ used to compute the moving average data point can be stored to contention candidate data set dₓ.

In some examples, only those pivot angles that are equal to or less than a threshold degradation may be used to construct the contention candidate data set dₓ. For example, the threshold degradation may be as an angle set that represents significant stress in the performance metric and/or a bottleneck in the execution of the workload. As an example, the threshold degradation may be set as a pivot angle of −30 degrees (e.g., 30 degrees below horizontal). In this case, smoothened data points associated with a pivot angle that is equal to or less than −30 degrees may be used to populate the contention candidate data set d_{x.} While an example threshold degradation is provided herein, the threshold degradation may be tunable as desired for a given application and desired performance.

Furthermore, in examples, the contention candidate data set dₓ may be populated with data points corresponding in performance drops followed by extending landings in performance that occurring for a period of time that exceed a threshold period of time. Thus, block 510 may include, upon identifying a first pivot angle that is less than or equal to the threshold degradation and checking if pivot angles for the threshold period of time following the detected drop in performance fall within a threshold deviation range relative to horizontal. For example, the threshold deviation range may be set at +/− a deviation angle (e.g., 30 degrees in an example). If any of the pivot angels are outside the threshold deviation range (e.g., an absolute value of the pivot angle is greater than the absolute value of the deviation angle) within the threshold period of time (e.g., 5 minutes in some examples, but may be tuned as desired for a given performance), then the smoothened data points corresponding to the pivot angle are not used to populate the contention candidate data set dₓ, because these points may not represent lasting performance contentions. The absolute value of the threshold deviation range need not be equal to the absolute value of the threshold degradation, described above.

Zoomed in region 702 of performance graph 700 illustrates an example of block 510. Zoomed in region 702 depicts various smoothened data points, including 706A-706F. Tangents 704A-704F were computed for smoothened data point 706A-706F and pivot angles of each tangent 704A-704F were checked with respect to the horizontal against a threshold degradation of −30 degrees. As shown in zoomed in region 702, smoothened data point 706A has a tangent that is less than −30 degrees, which represents a performance drop and a potential start of a landing. To confirm landing of steady performance, tangents for moving average data points 706B-706F are checked against the threshold deviation range and the threshold period of time. Tangent 704A-704E have pivot angles that fall in the range of the threshold deviation range (e.g., >=−30° to <=30°) and can be considered as part of the extended landing. While, tangent 704F has a positive pivot angel that falls out of the range (e.g., >30°) and thus is not part of the landing. Additionally, the length of time between moving average data points 706A-706E exceeds the threshold period of time (e.g., 5 minutes) and thus can be considered an extended landing. The execution environment information, such as computation resources, corresponding to the performance data points of smoothened data points 706A-706E can be considered a portion of the ML pipeline 202 subject to poor performance resulting from contentions.

At block 512, the contention candidate data set dₓ may be divided into smaller data sets dₓ₁ . . . dₓₚ and blocks 502-510 may be repeated for a more granular analysis. In some examples, only the data points corresponding to negative pivot angles need be analyzed to provide a reduced time to solution.

At block 514, a set of contention candidate data sets with extended landing can be saved as {d_{N1} . . . d_{Nn}}. Execution environment information, including compute, storage and network configuration information corresponding to the data points that make up a set of contention candidate data sets, can be stored as well for evaluation to understand the root cause of the performance drops. The set of content candidate points {d_{N1} . . . d_{Nn}} may be unique to the execution of the workload and can be preserved for provenance and use as input to the other algorithms, such as the RDA described below.

FIGS. 8A and 8B depict a flow chart of an example rhythm detection flow 800, in accordance with an example of the present disclosure. The rhythm detection flow 800 (herein referred to as flow 800) may be implemented as instructions, for example, stored in a memory, that when executed by one or more processors perform one or more operations of flow 800. For example, flow 800 may be implemented as instructions stored in computer readable medium 114 of FIG. 1, that when executed by processor(s) 112 perform one or more operations of flow 800. Flow 800 may be an example of an RDA that can be executed by the mediation module 214 of FIG. 2.

In examples, flow 800 may use the set of contention candidate data sets {d_{N1} . . . d_{Nn}} as inputs, which includes information on which execution of the ML pipeline has encountered extended performance drops due to, for example, hardware constraints, hardware failure, and/or network constraints. The flow 800 progressively detects rhythmic patterns among multiple sets of contention candidate data sets {d_{N1} . . . d_{Nn}} from multiple executions of the ML pipeline. In examples, to ferret out rhythmic patterns in performance graphs, the examples herein may take the sets of contention candidates {d_{N1} . . . d_{Nn}} from one execution as a reference set and compare it to a comparison set obtained from a subsequent execution. Examples can build a correlation between the performance drops observed between different executions, which can be identified as contentious operations of the ML workload. This feedback mechanism not only helps the examples disclosed herein to progressively mediate and overcome contentions in subsequent executions, but can also help in re-validating previous decisions, thereby creating a self-learning and self-adjusting mediation layer which can get better in optimization of the execution environment for each subsequent execution.

At block 802, a reference contention candidate data set x and a comparison contention candidate data set y can be obtained. In an example, the reference contention candidate set x can be obtained from flow 500 as {d_{NR1} . . . d_{NRn}}, which provides performance drop points with extended landings (e.g., contention candidates) as described above. In some examples, the reference contention candidate set x can be a baseline or ground truth content candidate constructed over multiple executions. The comparison contention candidate set y can be obtained from flow 500 as {d_{NC1} . . . d_{NCn}} determined from data collected during a subsequent execution of the ML pipeline, which also has performance drops points with extended landings. The contention candidate set y may be considered a current execution and the reference contention candidate data set x may be considered an execution performed prior to the current execution. Each data point in the two sets can be used as a data point in the performance timeline where the flow 800 may commence. Each point in contention candidate data sets x and y may correspond to times tₓ and t_{y}, respectively.

The goal of flow 800 may be to identify if there are repeating patterns (referred to as rhythmic patterns) amongst these contention candidate data sets. Once a rhythmic pattern is detected, execution environment information (e.g., obtained from telemetry data) related to these rhythmic points can be compared to identify root causes and take corrective actions for executions subsequent to the comparison contention candidate data set y, for example, as described above in connection with FIGS. 2-4. The corrective actions may be utilized to avert possible performance bottlenecks/losses and ensure optimal use of the computation resources at disposal.

At block 804, subsets of data points from the reference and comparison contention candidate data sets surrounding a performance drop point can be extracted for correlation analysis. For example, a performance drop point may be selected as any one of the data points contained in the comparison contention candidate data set y. The performance drop point may be set as a mid-point at times tₓ and t_{y}, respectively. The subsets of data points may set as a range (e.g., number) of data points from the reference and comparison contention candidate data sets that occurred in time prior to and after the mid-point. For example, the subsets of data points of the reference contention candidate data set may include a range of data points from the reference contention candidate data set consisting of −n to +n number of data points, where n is a number of data points on either side of the performance drop point as a mid-point. Likewise, the subsets of data points of the comparison contention candidate data set may include a range of data points from the comparison contention candidate data set consisting of −n to +n number of data points.

At block 806, a plurality of correlations values can be computed between the subsets of data points obtained at block 804 as a function of a time lag (τ). For example, correlation values (R) can be computed as:

R_{xy}(τ)=Σ_{tx-n,ty-n}^{tx+n,ty+n}x(tₓ)*y(t_{y}+τ) Eq. 1
where the time lag (τ) is varied through a plurality of integers. For example, the time lag (τ) can be varied from −1, 0, and 1. For different values of time lag (τ), Eq. 1 outputs a different correlation value (e.g., three in this case).

At block 808, the highest correlation value from the plurality of correlations can be identified and stored as a comparison point (R_{H1}). The highest correlation value among these different correlation values may indicate a direction of increasing correlation for progressing between the subsets of data points.

At block 810, a determination is made whether or not the correlation value of comparison point (R_{H1}) is greater than a threshold correlation value (Cᵥ). The threshold correlation value (Cᵥ) may be a value set in advance based on the desired application and performance. If the correlation value of the comparison point (R_{H1}) exceeds the threshold correlation value (Cᵥ), the flow 800 proceeds to block 814 for the data point at t_{y}. Otherwise, the subset of comparison contention candidate data set y is incremented to the next data point along the time horizon by incrementing time t_{y} to the next smoothened data point of the contention candidate data set y, at block 812. Flow 800 repeats block 804 with the next smoothened data point as the performance drop point.

In examples, the threshold correlation value Cᵥ can be selected using various methods. For example, a user may set the threshold correlation value (Cᵥ), for example, if the user is aware of the expected maximum correlation value between the two comparison sets. If the data is noisy, then statistical methods can be used to obtain the threshold correlation value (Cᵥ). For example, the threshold correlation value (Cᵥ) can be computed from a mean of correlations values (m) and a standard deviation in correlation value(s). In an example, threshold correlation value (Cᵥ) can be computed as the mean plus two times the standard deviation. In another example, threshold correlation value (Cᵥ) can be determined using a percentage of maximum value of the correlation value, for example, threshold correlation value (Cᵥ) can be computed as 80% or 90% of the maximum of correlation value.

At block 814, the subset of data points from the comparison contention candidate data set surrounding the performance drop point can be shifted based on the time lag (τ) associated with comparison point (R_{H1}) (e.g., time lag value that resulted in highest correlation value at block 808). In examples, the subsets of data points can be shifted in a direction corresponding to the time lag (τ) value associated with comparison point (R_{H1}). For example, if a time lag (τ) value of −1 resulted in the highest comparison point (R_{H1}), the range of data points for the comparison contention candidate data set y can be shifted in the negative direction relative to the performance drop point. If a time lag (τ) value of 1 resulted in the highest comparison point (R_{H1}), the range of data points for the comparison contention candidate data set y can be shifted toward the positive direction relative to the performance drop point. If a time lag (τ) value of 0 resulted in the highest comparison point (R_{H1}), the range of data points for the comparison contention candidate data set y can be shifted in both the positive and negative directions. The amount of the shift may be based on an expansion value, which may be a percentage of the entire range. For example, the expansion value may be set to 30%, which may shift the range of data points constituting the subsets by 30% according to the directions determined from the time lag (τ) value.

Also at block 814, a plurality of correlations values can be computed between the shifted subset of data points from comparison contention candidate data set and the subset of data points from the reference contention candidate data set obtained at block 804 as a function of the time lag (τ). For example, the correlation (R) can be computed as:

R_{xy}(τ)=Σ_{tx-n,ty-n+Ev}^{tx+n,ty+n+Ev}x(tₓ)*y(t_{y}+τ) Eq. 2

Where Ev represents the expansion value and a direction (e.g., positive or negative) that is dependent on the time lag (τ) value associated with comparison point (R_{H1}), as described above. For example, if a time lag (τ) value of −1 resulted in the highest comparison point (R_{H1}) and the absolute value of the expansion value is set to 30%, Ev in Eq. 2 may be −3 (e.g., a negative direction shift of the range). If a time lag (τ) value of 1 resulted in the highest comparison point (R_{H1}) and the absolute value of the expansion value is set to 30%, Ev in Eq. 2 may be +3 (e.g., a positive direction shift of the range). If a time lag (τ) value of 0 resulted in the highest comparison point (R_{H1}) and the absolute value of the expansion value is set to 30%, Ev may be set to +3 on the upper bound of the summation of Eq. 2 and −3 on the lower bound of the summation of Eq. 2. Equations 3-5 below depict the above examples for time lag (τ) value of −1, 0, and 1 associated with comparison point (R_{H1}), respectively.

R_{xy}(τ)=Σ_{tx-n,ty-n-3}^{tx+n,ty+n-3}x(tₓ)*y(t_{y}+τ) Eq. 3

R_{xy}(τ)=Σ_{tx-n,ty-n-3}^{tx+n,ty+n+3}x(tₓ)*y(t_{y}+τ) Eq. 4

R_{xy}(τ)=Σ_{tx-n,ty-n+3}^{tx+n,ty+n+3}x(tₓ)*y(t_{y}+τ) Eq. 5

At block 816, the highest correlation value from the plurality of correlations values from block 814 can be identified and stored as a comparison point (R_{H2}). Comparison point (R_{H2}) is compared to comparison point (R_{H1}) at block 818 to check if the correlation value is increasing. If the comparison point (R_{H2}) is equal to or greater than comparison point (R_{H1}), which indicates increasing correlation, flow 800 proceeds to block 820. At block 820, comparison point (R_{H2}) replaces comparison point (R_{H1}) and is stored for repeating blocks 814-818 using comparison point (R_{H2}) as comparison point (R_{H1}).

If comparison point (R_{H2}) is less than comparison point (R_{H1}), which indicates a decrease in correlation, flow 800 proceeds to block 822. At this point, comparison point (R_{H1}) may be considered the final correlation point due and represents that the subset of comparison contention candidate data set y corresponding to the current comparison point (R_{H1}) is in rhythm with the subset of reference contention candidate data set x (e.g., the subset obtained at block 804). The correlated data points (also referred to herein as correlated entries) constituting the subset of comparison contention candidate data set y corresponding to the current comparison point (R_{H1}) can be stored in association with the subset of reference contention candidate data set x to construct a rhythmic pattern data set, as {(xₙ, yₘ) . . . }. The rhythmic pattern data set of correlated data points may represent a contention that repeatedly occurs during the execution of the workload. The rhythmic pattern data set can be associated with execution environment information corresponding to the underlying performance data points. The rhythmic pattern data set and associated execution environment information can be used as inputs for resolving the contention during a subsequent execution.

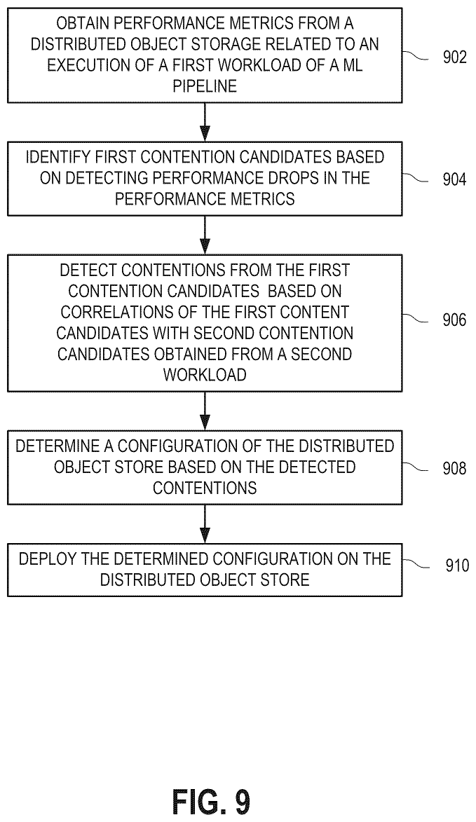

FIG. 9 illustrates a process flow 900 for contention mediation in accordance with an example implementation. Process flow 900 may be implemented as instructions, for example, stored in a memory, that when executed by one or more processors perform one or more operations of process flow 900. For example, process flow 900 may be implemented as instructions stored in computer readable medium 114, that when executed by processor(s) 112 perform one or more operations of process flow 900. However, one skilled in the art will appreciate that the embodiments disclosed herein are not to be limited to this implementation only. For example, flow 900 may be implemented as instructions stored in a cloud-based architecture.

At block 902, performance metrics can be obtained from a distributed object storage related to an execution of a first workload of an ML pipeline. For example, with reference to FIG. 1, the contention mediation system 110 may obtain performance metrics from distributed environment 100, such as, in some examples, from distributed storage system 104 as an example of a distributed object storage. In some examples, performance metrics can also be obtained from network 130 and/or compute infrastructure 102. The performance metrics may be related to an execution of a workload, such as tasks or phases of the ML pipeline. The ML pipeline may be, in some example, a distributed ML pipeline having workloads executed by distributed applications running within the distributed environment 100 (e.g., on compute nodes 120). In some examples, the contention mediation system may include a POME (e.g., POME 212 of FIG. 2) that can be executed to obtain performance metrics.

At block 904, first contention candidates may be identified based on detecting performance drops in the performance metrics. In some example, block 904 may be executed by a contention mediation system (e.g., contention mediation system 110 and/or 210) to detect extended performance drops and identify first contention candidates from the extended performance drops.

At block 906, contentions can be detected from the first contention candidates based on correlating the first content candidates with second contention candidates obtained from a second workload. In some example, block 906 may be executed by a contention mediation system (e.g., contention mediation system 110 and/or 210) to detect contentions by correlating the first contention candidates with second contention candidates identified from a prior execution of the workload.

At block 908, a configuration of the distributed object store can be determined based on the detected contentions. For example, the detected contentions can be provided as a set of data points of performance metrics with timestamps. Information related to the environment in which the workload was executed corresponding to the performance metrics according to the timestamps can be obtained, which can be representative of a first configuration of the execution environment that experienced the performance drops across multiple executions. From this, a root cause of the performance drops can determined and a second configuration that mitigates the root cause can be determined.

At block 910, the determined configuration can be deployed on the distributed object store for use in executing a subsequent workload of the ML pipeline.

In some examples, the performance metrics obtained at block 902 may include characterizations of I/O operations on the distributed object storage. In this case, the correlations of the first content candidates with second contention candidates at block 906 may be indicative of a repeated pattern of contentions between I/O operations related to the execution of the ML pipeline.

In some examples, the performance metrics obtained at block 902 may comprise a set of performance data points. In this case, the first contention candidates identified at block 904 can be identified based on detecting performance drops in the performance metrics by identifying one or more subsets of the performance data points that satisfy performance deviation criteria. The one or more subsets of the performance data points may be stored as the contention candidates. In examples, detecting contentions at block 906 can include retrieving the second contention candidates and iteratively computing, using a rhythm detection algorithm (RDA), correlation values between the first contention candidates and the second contention candidates. Responsive to a current correlation value being less than a preceding correlation value, the example may construct a set of correlated entries that are indicative of contentions. The set of correlated entries may include a first contention candidate and a second contention candidate corresponding to the preceding correlation value.

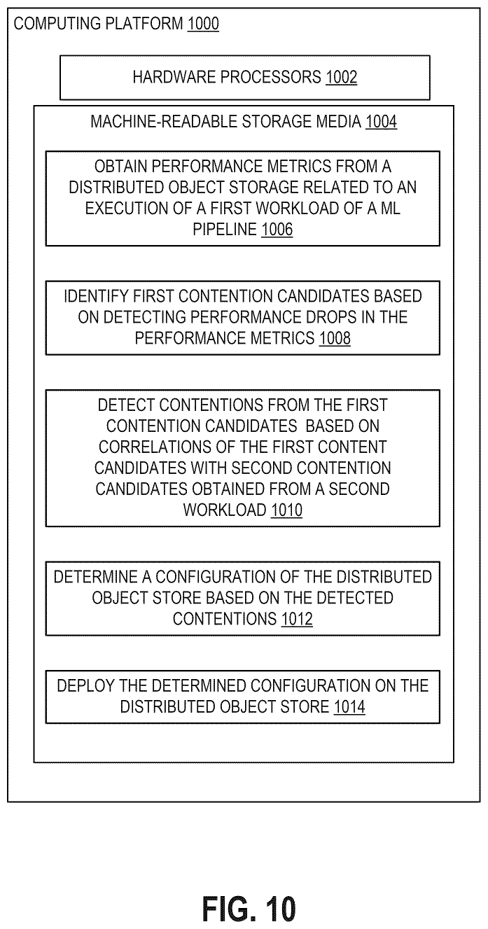

FIG. 10 illustrates a computing component that may be used to implement contention mediation in accordance with various examples of the disclosed technology. Referring now to FIG. 10, computing component 1000 may be, for example, a server computer, a controller, or any other similar computing component capable of processing data. In the example implementation of FIG. 10, the computing component 1000 includes a hardware processor 1002, and machine-readable storage medium for 1004.

Hardware processor 1002 may be one or more central processing units (CPUs), semiconductor-based microprocessors, and/or other hardware devices suitable for retrieval and execution of instructions stored in machine-readable storage medium 1004. Hardware processor 1002 may fetch, decode, and execute instructions, such as instructions 1006-1014, to control processes or operations disclosed herein. As an alternative or in addition to retrieving and executing instructions, hardware processor 1002 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1004, may be any electronic, magnetic, optical, or other physical storage device that contains or stores executable instructions. Thus, machine-readable storage medium 1004 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 1004 may be a non-transitory storage medium, where the term “non-transitory” does not encompass transitory propagating signals. As described in detail below, machine-readable storage medium 1004 may be encoded with executable instructions, for example, instructions 1006-1014.

Hardware processor 1002 may execute instruction 1006 to obtain performance metrics from a distributed object storage related to an execution of a first workload of an ML pipeline. For example, with reference to FIG. 1, the contention mediation system 110 may obtain performance metrics from distributed environment 100, such as, in some examples, from distributed storage system 104 as an example of a distributed object storage. In some examples, performance metrics can also be obtained from network 130 and/or compute infrastructure 102. The performance metrics may be related to an execution of a workload, such as tasks or phases of the ML pipeline. The ML pipeline may be, in some example, a distributed ML pipeline having workloads executed by distributed applications running within the distributed environment 100 (e.g., on compute nodes 120). In some examples, the contention mediation system may include a POME (e.g., POME 212 of FIG. 2) that can be executed to obtain performance metrics.

Hardware processor 1002 may execute instruction 1008 to identify first contention candidates based on detecting performance drops in the performance metrics. In some example, instruction 1008 may be executed by a contention mediation system (e.g., contention mediation system 110 and/or 210) to detect extended performance drops and identify first contention candidates from the extended performance drops.

Hardware processor 1002 may execute instruction 1010 to detect contentions from the first contention candidates based on correlating the first content candidates with second contention candidates obtained from a second workload. In some example, instruction 1010 may be executed by a contention mediation system (e.g., contention mediation system 110 and/or 210) to detect contentions by correlating the first contention candidates with second contention candidates identified from a prior execution of the workload.

Hardware processor 1002 may execute instruction 1012 to determine a configuration of the distributed object store based on the detected contentions. For example, the detected contentions can be provided as a set of data points of performance metrics with timestamps. Information related to the environment in which the workload was executed corresponding to the performance metrics according to the timestamps can be obtained, which can be representative of a first configuration of the execution environment that experienced the performance drops across multiple executions. From this, a root cause of the performance drops can determined and a second configuration that mitigates the root cause can be determined.

Hardware processor 1002 may execute instruction 1014 to deploy the determined configuration on the distributed object store for use in executing a subsequent workload of the ML pipeline.

In some examples, the performance metrics obtained by instructions 1006 may include characterizations of I/O operations on the distributed object storage. In this case, the correlations of the first content candidates with second contention candidates at instructions 1010 may be indicative of a repeated pattern of contentions between I/O operations related to the execution of the ML pipeline.

In some examples, the performance metrics obtained by instructions 1006 may comprise a set of performance data points. In this case, the first contention candidates identified by instructions 1008 can be identified based on detecting performance drops in the performance metrics by identifying one or more subsets of the performance data points that satisfy performance deviation criteria. The one or more subsets of the performance data points may be stored as the contention candidates. In examples, detecting contentions at instructions 1010 can include retrieving the second contention candidates and iteratively computing, using a rhythm detection algorithm (RDA), correlation values between the first contention candidates and the second contention candidates. Responsive to a current correlation value being less than a preceding correlation value, the example may construct a set of correlated entries that are indicative of contentions. The set of correlated entries may include a first contention candidate and a second contention candidate corresponding to the preceding correlation value.

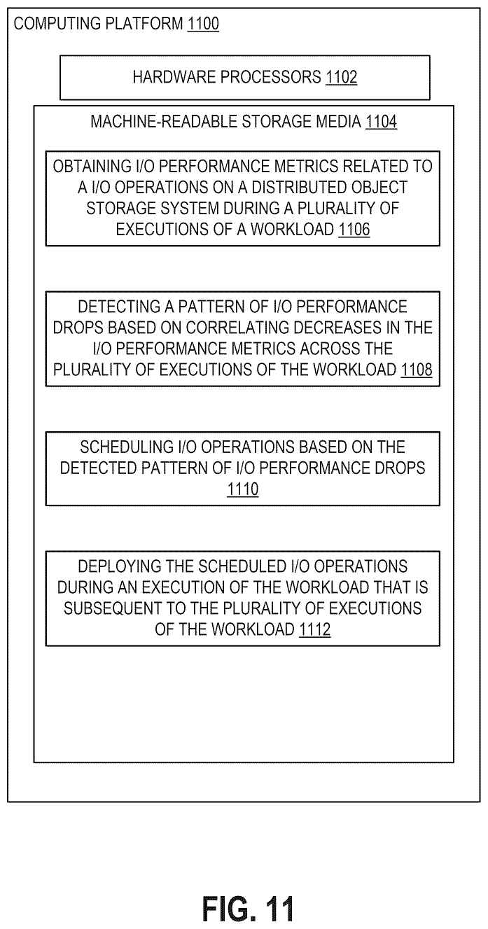

FIG. 11 illustrates a computing component that may be used to implement I/O contention mediation in accordance with various examples of the disclosed technology. Referring now to FIG. 11, computing component 1100 may be, for example, a server computer, a controller, or any other similar computing component capable of processing data. In the example implementation of FIG. 11, the computing component 1100 includes a hardware processor 1102, and machine-readable storage medium for 1104.

Hardware processor 1102 may be one or more central processing units (CPUs), semiconductor-based microprocessors, and/or other hardware devices suitable for retrieval and execution of instructions stored in machine-readable storage medium 1104. Hardware processor 1102 may fetch, decode, and execute instructions, such as instructions 1106-1114, to control processes or operations disclosed herein. As an alternative or in addition to retrieving and executing instructions, hardware processor 1102 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1104, may be any electronic, magnetic, optical, or other physical storage device that contains or stores executable instructions. Thus, machine-readable storage medium 1104 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 1104 may be a non-transitory storage medium, where the term “non-transitory” does not encompass transitory propagating signals. As described in detail below, machine-readable storage medium 1104 may be encoded with executable instructions, for example, instructions 1106-1114.

Hardware processor 1102 may execute instruction 1106 to I/O performance metrics related to a I/O operations on a distributed object storage system during a plurality of executions of a workload. For example, with reference to FIG. 1, the contention mediation system 110 may obtain I/O performance metrics from distributed storage system 114 as an example of a distributed object storage. The I/O performance metrics may be related to executions of a workload, such as tasks or phases of the ML pipeline. In some examples, the contention mediation system may include a POME (e.g., POME 212 of FIG. 2) that can be executed to obtain the I/O performance metrics.

Hardware processor 1102 may execute instruction 1108 to a pattern of I/O performance drops based on correlating decreases in the I/O performance metrics across the plurality of executions of the workload. For example, for each of the plurality of executions, contention candidates can be identified based on detecting I/O performance drops in the I/O performance metrics and contentious I/O operations can be detected based on correlating contention candidates across the plurality of executions. In some example, instruction 1108 may be executed by a contention mediation system (e.g., contention mediation system 110 and/or 210) to detect extended I/O performance drops and identify contention candidates from the extended I/O performance drops. In some examples, the correlations of the content candidates may be indicative of repeated patterns of contentions between I/O operations related to the executions.

Hardware processor 1102 may execute instruction 1110 to detect contentions from the first contention candidates based on correlating the first content candidates with second contention candidates obtained from a second workload. In some example, instruction 1110 may be executed by a contention mediation system (e.g., contention mediation system 110 and/or 210) to detect contentions by correlating the first contention candidates with second contention candidates identified from a prior execution of the workload.

Hardware processor 1102 may execute instruction 1112 to schedule I/O operations based on the detected pattern of I/O performance drops. For example, the detected pattern of I/O performance drops can be provided as a set of data points of I/O performance metrics with timestamps. Information related to the execution environment in which the workload was executed corresponding to the I/O performance metrics according to the timestamps can be obtained, which can be representative of operations that experienced the performance drops across multiple executions. From this, a root cause of the I/O performance drops can determined and I/O operations can be scheduled so to mitigate the I/O performance drops in future executions.

Hardware processor 1102 may execute instruction 1114 to deploy the scheduled I/O operations during an execution of the workload that is subsequent to the plurality of executions of the workload. For example, operations can be scheduled and deployed as described above in connection with FIGS. 3 and 4.

In some examples, the performance metrics obtained by instructions 1106 may comprise a set of performance data points. In this case, the contention candidates identified by instructions 1108 can be identified based on detecting I/O performance drops in the I/O performance metrics by identifying one or more subsets of the performance data points that satisfy performance deviation criteria. The one or more subsets of the performance data points may be stored as the contention candidates. In examples, detecting contentions at instructions 1110 can include retrieving the second contention candidates and iteratively computing, using a rhythm detection algorithm (RDA), correlation values between the first contention candidates and the second contention candidates. Responsive to a current correlation value being less than a preceding correlation value, the example may construct a set of correlated entries that are indicative of contentions. The set of correlated entries may include a first contention candidate and a second contention candidate corresponding to the preceding correlation value.

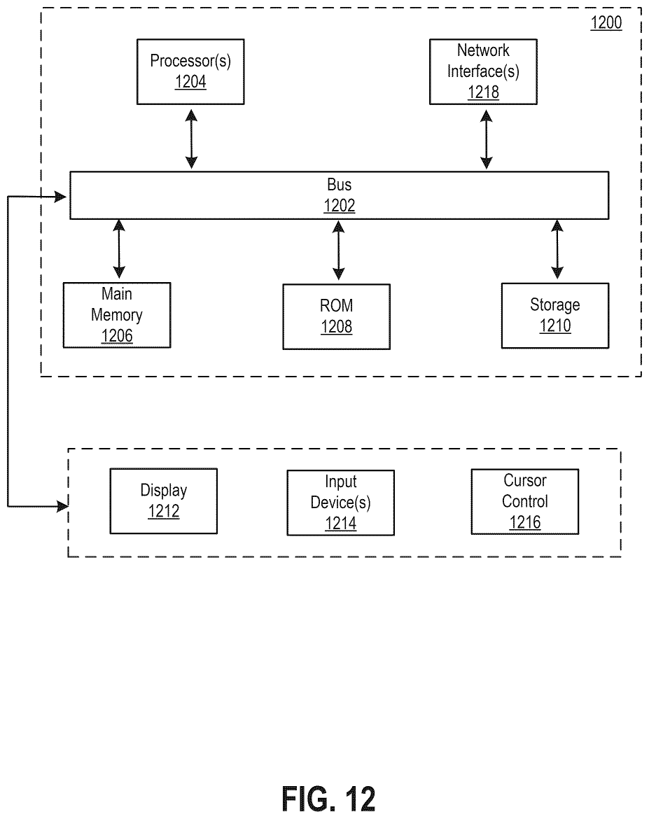

FIG. 12 depicts a block diagram of an example computer system 1200 in which various examples of the disclosed technology described herein may be implemented. The computer system 1200 includes a bus 1202 or other communication mechanism for communicating information, one or more hardware processors 1204 coupled with bus 1202 for processing information. Hardware processor(s) 1204 may be, for example, one or more general purpose microprocessors. The computer system 1200 may be implemented as one or more component described in connection with FIGS. 1 and 2. For example, computer system 1200 may be implemented as one or more compute nodes 120, distributed storage nodes 140, and/or contention mediation system 110 of FIG. 1, as well as the ML Pipeline 202, distributed object storage platform 204, and/or contention mediation system 210 of FIG. 2.

The computer system 1200 also includes a main memory 1206, such as a random access memory (RAM), cache and/or other dynamic storage devices, coupled to bus 1202 for storing information and instructions to be executed by processor 1204. Main memory 1206 also may be used for storing temporary variables or other intermediate information during execution of instructions to be executed by processor 1204. Such instructions, when stored in storage media accessible to processor 1204, render computer system 1200 into a special-purpose machine that is customized to perform the operations specified in the instructions. For example, main memory 1206 may store instructions, that when executed by processor(s) 1204, cause computer system 1200 to perform one or more of the operations described in connection with FIGS. 3-5 and 8A-11.

The computer system 1200 further includes a read only memory (ROM) 1208 or other static storage device coupled to bus 1202 for storing static information and instructions for processor 1204. A storage device 1210, such as a magnetic disk, optical disk, or USB thumb drive (Flash drive), etc., is provided and coupled to bus 1202 for storing information and instructions.

The computer system 1200 may be coupled via bus 1202 to a display 1212, such as a liquid crystal display (LCD) (or touch screen), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. In some examples, the same direction information and command selections as cursor control may be implemented via receiving touches on a touch screen without a cursor.

The computing system 1200 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1200 may implement the techniques described herein using customized hard-wired logic, one or more ASICs or FPGAs, firmware and/or program logic which in combination with the computer system causes or programs computer system 1200 to be a special-purpose machine. According to one example of the disclosed technology, the techniques herein are performed by computer system 1200 in response to processor(s) 1204 executing one or more sequences of one or more instructions contained in main memory 1206. Such instructions may be read into main memory 1206 from another storage medium, such as storage device 1210. Execution of the sequences of instructions contained in main memory 1206 causes processor(s) 1204 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1210. Volatile media includes dynamic memory, such as main memory 1206. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1202. Transmission media can also take the form of acoustic or light waves, such as those generated during radio-wave and infra-red data communications.

The computer system 1200 also includes a network interface 1218 (also referred to as a communication interface) coupled to bus 1202. Network interface 1218 provides a two-way data communication coupling to one or more network links that are connected to one or more local networks. For example, communication interface 1218 may be an integrated services digital network (ISDN) card, cable modem, satellite modem, or a modem to provide a data communication connection to a corresponding type of telephone line. As another example, network interface 1218 may be a local area network (LAN) card to provide a data communication connection to a compatible LAN (or WAN component to communicate with a WAN). Wireless links may also be implemented. In any such implementation, network interface 1218 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 1218, which carry the digital data to and from computer system 1200, are example forms of transmission media.

The computer system 1200 can send messages and receive data, including program code, through the network(s), network link and network interface 1218. In the Internet example, a server might transmit a requested code for an application program through the Internet, the ISP, the local network and the network interface 1218.

The received code may be executed by processor 1204 as it is received, and/or stored in storage device 1210, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1200.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a memory storing instructions; and
a processor operably connected to the memory and configured to execute the instructions to:
obtain performance metrics from a distributed object storage related to an execution of a first workload of a machine learning (ML) pipeline;
identify first contention candidates based on detecting performance drops in the performance metrics;
detect contentions from the first contention candidates based on correlations of the first content candidates with second contention candidates obtained from a second workload;
determine a configuration of the distributed object store based on the detected contentions; and
deploy the determined configuration on the distributed object store.

2. The system of claim 1, wherein the second workload is performed prior to the first workload.

3. The system of claim 1, wherein the performance metrics comprise a set of performance data points, and wherein identifying the first contention candidates based on detecting performance drops in the performance metrics comprises:
identifying one or more subsets of the performance data points that satisfy performance deviation criteria; and
storing the one or more subsets of the performance data points as the contention candidates.

4. The system of claim 3, wherein performance deviation criteria comprises a threshold deviation range and a threshold period of time.

5. The system of claim 4, wherein identifying one or more subsets of the performance data points that satisfy performance deviation criteria comprises:
computing tangents for performance data points in the subsets of the performance data points; and
determining that the tangents are equal to or less than a threshold deviation range for a period of time that is equal to or longer than the threshold period of time.

6. The system of claim 3, wherein detecting contentions from the first contention candidates comprises:
retrieving the second contention candidates;
iteratively computing, using a rhythm detection algorithm, correlation values between the first contention candidates and the second contention candidates; and
responsive to a current correlation value being less than a preceding correlation value, constructing a set of correlated entries comprising a first contention candidate and a second contention candidate corresponding to the preceding correlation value,
wherein the set of correlated entries is indicative of contentions.

7. The system of claim 6, wherein the processor is further configured to execute the instructions to:
obtain configuration information indicative of a configuration of the distributed object storage related to the execution of the first workload; and
determine contentious configurations by comparing the configuration information corresponding to the first contention candidate of the set of correlated entries with configuration information corresponding to the second contention candidate of the set of correlated entries,
wherein the determined configuration of the distributed object store is determined to mitigate the contentious configurations.

8. The system of claim 1, wherein the performance metrics comprise characterizations of input/output (I/O) operations on the distributed object storage, and wherein the correlations of the first content candidates with second contention candidates are indicative of a repeated pattern of contentions between I/O operations related to the execution of the ML pipeline.

9. The system of claim 8, wherein determining the configuration of the distributed object store based on the detected contentions comprises:
scheduling I/O operations related to an execution of a third workload based on the repeated pattern of contentions between I/O operations related to the execution of the ML pipeline.

10. A method comprising:
obtaining performance metrics from a distributed object storage related to an execution of a first workload of a machine learning (ML) pipeline;
identifying first contention candidates based on detecting performance drops in the performance metrics;
detecting contentions from the first contention candidates based on correlations of the first content candidates with second contention candidates obtained from a second workload;
determining a configuration of the distributed object store based on the detected contentions; and
deploying the determined configuration on the distributed object store.

11. The method of claim 10, wherein the second workload is performed prior to the first workload.

12. The method of claim 10, wherein the performance metrics comprise a set of performance data points, and wherein identifying the first contention candidates based on detecting performance drops in the performance metrics comprises:
identifying one or more subsets of the performance data points that satisfy performance deviation criteria; and
storing the one or more subsets of the performance data points as the contention candidates.

13. The method of claim 12, wherein detecting contentions from the first contention candidates comprises:
retrieving the second contention candidates;
iteratively computing, using a rhythm detection algorithm, correlation values between the first contention candidates and the second contention candidates; and
responsive to a current correlation value being less than a preceding correlation value, constructing a set of correlated entries comprising a first contention candidate and a second contention candidate corresponding to the preceding correlation value,
wherein the set of correlated entries is indicative of contentions.

14. The method of claim 13, further comprising:
obtaining configuration information indicative of a configuration of the distributed object storage related to the execution of the first workload; and
determining contentious configurations by comparing the configuration information corresponding to the first contention candidate of the set of correlated entries with configuration information corresponding to the second contention candidate of the set of correlated entries,
wherein the determined configuration of the distributed object store is determined to mitigate the contentious configurations.

15. The method of claim 10, wherein the performance metrics comprise characterizations of input/output (I/O) operations on the distributed object storage, and wherein the correlations of the first content candidates with second contention candidates are indicative of a repeated pattern of contentions between I/O operations related to the execution of the ML pipeline.

16. The method of claim 15, wherein determining the configuration of the distributed object store based on the detected contentions comprises:
scheduling I/O operations related to an execution of a third workload based on the repeated pattern of contentions between I/O operations related to the execution of the ML pipeline.

17. A non-transitory computer-readable storage medium including instructions that, when executed by at least one processor of a computing system, cause the computing system to perform a method comprising:
obtaining input/output (I/O) performance metrics related to a I/O operations on a distributed object storage system during a plurality of executions of a workload;
detecting a pattern of I/O performance drops based on correlating decreases in the I/O performance metrics across the plurality of executions of the workload;
scheduling I/O operations based on the detected pattern of I/O performance drops; and
deploying the scheduled I/O operations during an execution of the workload that is subsequent to the plurality of executions of the workload.

18. The non-transitory computer-readable storage medium of claim 17, wherein detecting the pattern of I/O performance drops comprises:
for each of the plurality of executions, identifying contention candidates based on detecting I/O performance drops in the I/O performance metrics; and
detecting contentious I/O operations based on correlating contention candidates across the plurality of executions.

19. The non-transitory computer-readable storage medium of claim 18, wherein the I/O performance metrics comprise a set of performance data points, and wherein identifying the contention candidates based on detecting I/O performance drops in the I/O performance metrics comprises:
identifying one or more subsets of the performance data points that satisfy performance deviation criteria; and
storing the one or more subsets of the performance data points as the contention candidates.

20. The non-transitory computer-readable storage medium of claim 19, wherein detecting contentions from the contention candidates comprises:
iteratively computing, using a rhythm detection algorithm, correlation values between the contention candidates of the plurality of executions; and
responsive to a current correlation value being less than a preceding correlation value, constructing a set of correlated entries comprising contention candidates corresponding to the preceding correlation value,
wherein the set of correlated entries is indicative of a contentious I/O operation.
